(19) United States
(12) Patent Application Publication
(10) Pub. No.: US 2008/0026131 A1
(43) Pub. Date: Jan. 31, 2008

(54) Process for preparing a sugar coating on an irregular shaped confection

(75) Inventors: Susan M. Benjamin, Harrisburg, PA (US); Shawn M. Bennett, Palmyra, PA (US); James C. Bew, New Cumberland, PA (US); Jordana L. Swank, Hamburg, PA (US)

Correspondence Address: Leopold Presser;Scully, Scott, Murphy & Presser, P.C., Ste.300, 400 Garden City Plaza, Garden City, NY, 11530, US

(73) Assignee: THE HERSHEY COMPANY, HERSHEY, PA (US)

(21) Appl. No.: 11/495,338

(22) Filed: Jul. 28, 2006

(51) Int. Cl. A23G 3/00

(52) U.S. Cl. 426/660

(57) ABSTRACT

The present invention is directed to a process for forming a hard sugar coating on an irregularly shaped chocolate confection which tapers into a pointed tip on said confection on a non-base portion thereof, which comprises forming a rounded contour on the base thereof and applying at least two coating syrups and preferably three coating syrups onto the surface of the confections under specific conditions and optionally polishing said confection. The present invention is also directed to the product formed from the process.

### FIELD OF THE INVENTION

The present invention is directed to a process for hard panning a bite sized irregular shaped confection with sugar to produce a sugar coated irregularly shaped confection and to the coated confectionery product obtained from the process.

### BACKGROUND OF THE INVENTION

Coated confectioneries, panning and particularly sugar shelled confectioneries have long been known. For example, Hershey-ets® chocolates are chocolate centers with sugar shell coatings. Other examples include Nestle's Smarties®, M&M's® chocolate candies and the like. All of these confections have hard coatings of sugar covering the chocolate center.

The process for coating centers of confectioneries, e.g., chocolate centers, is known as panning. The equipment that is typically used in this process consists of a motor-driven, revolving, open-mouthed pan, which is usually cylindrical or pear shaped. The formed center material, e.g., the chocolate, is placed in the pan and when the pan rotates, the centers tumble over one another, providing thorough mixing.

There are two types of panning known in the art. They are soft panning and hard panning.

Soft panning consists of alternative additions of syrup comprised of a sucrose and corn syrup blend which make the center material sticky, and of dry powdered sucrose, which adheres and dries on the surface. When the coating of the desired thickness is achieved, a finishing syrup, which contains flavor and color, is applied in layers thereto to provide a smooth surface. The resultant coating is relatively soft to bite and granular in texture.

Hard panning is a unit operation used in many fields, among which are the confectionery and pharmaceutical industries. The operation consists of creating a hard coating on the surface of products in solid form, in order to provide protection to the confections or in order to create an attractive appearance or pleasant taste. Hard panning is directed towards obtaining a sweet crispy sugar shell, which is desired in the field of confectioneries.

In hard panning, just as in soft panning, the center is coated with layers of syrup. This syrup must contain a crystallizable material, e.g. sucrose. However, instead of applying layers of powdered sucrose to dry the centers, in hard panning, dry air is blown over the surface of the coated candy to dry each layer of syrup. As a result of hard panning, the candy is coated with a continuum of thin layers of fine sucrose crystals, which produce a coating that is both smooth and crisp.

The methodology of hard panning confections has been practiced for a long time. As described above, the process includes placing the confections in a revolving drum which continuously agitates the confections, while a solution of the coating material is applied in doses. In many cases, the coating is applied by spraying the coating material over the confection in the rotating drum during agitation. Warm air or other drying gases are then used to evaporate the moisture in the syrup, which hardens each layer in preparation for application of subsequent layers.

The process is characterized by being comprised of many cycles. Each of the repetitive cycles comprises an initial step in which small quantities of syrup are applied onto the tumbling bed of the products to be coated, and a second step in which the sprayed syrups are spread homogenously over the surface of the products. During the second step, the coating application is paused and the confections to be coated are tumbled within the coating pan to avoid the agglomeration of the individual pieces of the product, which must remain separate. Finally, in the third step, the water contained in the syrup is evaporated by a dry hot air flow.

Various pan coating apparatuses are known in the art for effecting the coating. Some apparatuses utilized are shown and described in U.S. Pat. Nos. 3,448,718, 3,063,843, and 2,726,959, the contents of which are all incorporated by reference.

U.S. Pat. No. 4,334,493, the contents of which are incorporated by reference, shows a rotary drum type apparatus for applying a coating to pharmaceutical tablets. The apparatus includes a rotary drum supported by a frame for receiving a body of tablets to be coated by spraying with a solvent. The drum, which can be inclined through angles of about 10-20° in such a manner that its front surface is turned upwardly, includes a device which supplies a coating material into the interior of the drum and an inlet tube and an outlet tube to provide a supply of drying gas such as air to the interior. The support frame cooperates with an air section duct disposed on the front side of the support frame and an air exhaust duct disposed on the rear side of the support frame so that a smooth flow of a hot blast of air through the drum can be obtained.

Silesia Confiserie Manual No. 4. by Josef A Merl and K. W. Stock, Silesia Gerhad Hanke, KG, Abt. Fachbucherei, Neuss, Germany 1996, discloses various common methods utilized for coating pharmaceutical dragees. One method, also known as air borne spraying, utilizes spraying with binary nozzles. It describes a spray machine which is equipped with a binary nozzle which facilitates airborne spraying. A pressure-proof hose delivers compressed air to the gun (atomizer), while a second hose carries the spraying solution to the gun. The gun is fitted with a direct air inlet and a reducing valve. When the gun is opened, the solution is discharged and atomized, i.e., sprayed by the air that is released simultaneously.

The base angle of the nozzle is dependent upon the type of coating pan, but most spray nozzles feature a spraying angle between 40° and 90°. After passing through a fine sieve, which prevents the nozzle from clogging, the liquid that is sprayed is discharged into a pressure tank which is usually double walled. Moreover, double walled containers are used in order to maintain the mass at optimal operating temperature. The pressure tank is also fitted with a mixer to prevent the precipitation of the spraying liquid.

Since the atomizer cools down the spray solution, the spray guns are designed so that the spray liquid passes through the atomizer. For example, they are fitted with an additional heating device. The combination of airborne spraying machine with timers and time switches permits automatic operation.

However, the processes to date, have been used to coat pharmaceutical dragees or confections, e.g., chocolates which are regularly shaped, i.e., they are symmetrical, e.g., they are circular, spherical or oval-like, such as the M&M's® candies and Hershey-ets® chocolates. But, these techniques have not been used heretofore to coat irregularly shaped bite size confections, e.g., bite size chocolates, i.e., a chocolate shape which contains at least one point on the non-base area thereof or has at least one tapered area that culminates in a point, e.g., a conical shape, such as for example, Hershey's Kisses® chocolates. Unfortunately, it is not a simple application of these techniques to coat an irregularly shaped bite sized confections. There are many problems which required ingenuity to overcome in order to hard pan such irregularly shaped chocolate centers.

For example, when hard panning irregularly shaped chocolate centers, various considerations need to be taken into account. For example, they include the temperature control of the centers, the total solids of the sugars syrup, the use of sugars syrup air atomization, the speed of the rotating drum, the volume of the drying air, and the dew point of the drying. It is to be understood that sugar coating is effected utilizing a supersaturated sugar solution which is maintained at a temperature which is much greater than the melting point of chocolate, i.e., 37° C. Thus, too high a temperature may result in the melting of the chocolate center unless the proper conditions are utilized. In addition, the rate of crystallization needs to be controlled. If it is too fast or too slow, the result will be an uneven application of the coating. A sugar syrup of too low a solids content also results in the degradation of the sugar crystal layers buildup on the pointed tip. The lack of a sugar shell layer on the pointed tip is visually and functionally unacceptable. Furthermore, a sugar syrup with too high a solids concentration can prematurely crystallize in the syrup nozzles prior to deposition on the plurality of centers which can result in a rough and mottled surface.

Furthermore, the process requires a specific volume of drying air calculated on the basis of finished product batch weight. If the volume of drying air is too low, it will take longer for the syrups to dry, making the process inefficient.

Dew point is another factor that also affects the process. For example, the use of inadequate air dew point results in unsatisfactory drying rates that lead to exposure of the pointed tips, poor color uniformity and overall degradation of the sugar shell layers which is visually and functionally unacceptable.

The speed of the rotating drum also affects the quality of the product in hard panning irregularly shaped confectionery centers. As the chocolates are tumbling in the coating pan, the different pieces collide not only into each other, but also with the pan (or baffles thereon). If the coating pan is rotated too quickly, the collision between the particles can create too much friction between each of the particles or between the particles and the pan, thereby causing the breakage of the chocolate and/or erosion of the tip and of the shape of the chocolate due to melting; on the other hand, if the pan is rotated too slowly, then an uneven amount of coating may be dispersed onto the chocolate, causing a rough surface. Moreover, sugar aggregation may occur on the sides of the coating pan.

With respect to the parameters listed above, it was found by the inventors that each must be implemented and stringently controlled in order to realize successful hard panned sugar coating of the irregularly shaped confectionery centers.

Another problem that is encountered is that many confections have a flat base. Unfortunately, hard panning chocolate centers results in the centers becoming quite tacky. Consequently any center with a flat side has a tendency to stick together with a second piece of chocolate having a flat base during the coating process. This phenomenon, called “doubling”, needs to be avoided when preparing a coating of an irregular shaped chocolate center.

Thus, there is a need in the art to sugar coat bite size irregularly shaped confections so that the shape after the coating process is basically the same as the shape thereof before being subjected to coating. The present process overcomes these problems.

### BRIEF SUMMARY OF THE INVENTION

The present application is directed to a process for sugar coating with at least two syrups, a plurality of bite-sized irregularly shaped confections, having a non-flat base which comprises:
(a) placing said plurality of irregularly shaped confections into a coating pan apparatus equipped with (1) a coating pan comprised of a rotatable drum, preferably perforated, into which the irregularly shaped plurality of confections are placed, said drum being controlled by a variable speed drive which controls the speed of the rotation of said drum; (2) an air atomizer that sprays a fine mist of each of the syrups onto the plurality of irregularly shaped confections; (3) an air inlet line and air outlet line which blows a designated air volume onto or draws air away, respectively, from the plurality of irregularly shaped confections on the drum; (4) a means of controlling the dew point within a designated range; (5) tanks and lines leading from said tanks which supply the syrups to said atomizer;
(b) spraying, using an atomizer, while rotating said drum of the coating pan containing said plurality of confections, a gumming syrup onto the surface of the plurality of confections comprised of a supersaturated solution of crystallizable sugar and a binding agent, under conditions effective to uniformly coat the confections with said gumming syrup in an amount effective to bind a smoothing syrup thereon, and subsequently drying said gumming syrup thereon; said gumming syrup comprised of crystallizable sugar ranging from about 67% to about 78% (w/w) and total solids therein in an amount ranging from about 69% to about 80% (w/w), said gumming syrup being dried at a dew point of about 10 F to about 45 F, said drum being rotated at a peripheral speed ranging from about 18 to about 93 feet per minute (“fpm”) and the air volume blown onto the plurality of confections ranging from about 2.5 to about 20 cubic feet per minute per pound (“cfm/lb”) of confection;
(c) spraying, using an atomizer onto the surface of the product of (b), said smoothing syrup comprised of a supersaturated solution of crystallizable sugar, non-crystallizable sugar and optionally a whitening agent while rotating the drum of the coating pan containing the product (b) under conditions effective to uniformly coat the dried gumming syrup coating the confections in an amount effective to smooth the coated surfaces of and optionally form a white coat on the surfaces of the plurality of said confections, and subsequently drying the smoothing syrup thereon; whereby the total amount of crystallizable sugar present in the smoothing syrup ranges from about 67% to about 76% (w/w) sugar and the total solids present in the syrup ranges from about 69% to about 80% (w/w), said non-crystallizable sugar being present in sufficient quantities to prevent sugar crystallization, said smoothing syrup being dried at a dew point ranging from about 10 F to about 45 F and the air volume blowing onto the plurality of confections ranging from about 2.5 to about 20 cfm/lb, said drum being rotated at a peripheral speed ranging from about 18 to about 93 fpm;
(d) optionally applying a coloring syrup onto the surface of the product of (c) to completely coat said second component and color the bite-sized irregularly shaped confections; and
(e) optionally polishing said coated confection.

It is to be noted that unless a coloring syrup is applied over the smoothing syrup, and dried onto the surface of the plurality of confections, the smoothing syrup does not require the presence of a whitening agent. As described herein, the whitening agent forms the white coat on the surface of the confection and is a primer for the application of the coloring syrup. In other words, if a coloring syrup is applied over the surface of the plurality of confections, the smoothing syrup contains the whitening agent. It is preferred, as described hereinbelow, that the smoothing syrup contains the whitening agent, and the third layer comprising a coloring syrup is applied over the dried smoothing syrup on the surface of the confections.

This feature described in the above paragraph is applicable in not only this embodiment but in all of the other embodiments described herein.

In a second embodiment, the present invention is directed to a process for sugar coating with at least two syrups a plurality of bite sized irregularly shaped confections having a non-flat base which comprises:
(a) placing said plurality of irregularly shaped confections into a coating pan apparatus equipped with (1) a coating pan comprised of a rotatable drum, preferably perforated, into which the irregularly shaped plurality of confections are placed, said drum being controlled by a variable speed drive which controls the speed of the rotation of said drum; (2) an air atomizer that sprays a fine mist of each of the syrups onto the plurality of irregularly shaped confections; (3) an air inlet line and air outlet line which blows a designated air volume onto or draws air away, respectively, from the plurality of irregularly shaped confections on the drum; (4) a means of controlling the dew point of the air; and (5) tanks and lines leading from said tanks which supply said syrups to said atomizer;
(b) spraying, using an atomizer, while rotating said drum of the coating pan containing the plurality of confections, a gumming syrup comprised of a supersaturated solution of crystallizable sugar and a binding agent onto the surface of the plurality of confections under conditions effective to uniformly coat the confections with said gumming syrup and in an amount effective to bind to a smoothing syrup thereon, and subsequently drying said gumming syrup thereon; said gumming syrup comprised of crystallizable sugar ranging from about 67% to about 78% (w/w) and total solids therein in the amount of about 69% to about 80% (w/w), said process being effected at an air atomization pressure ranging from about 14 to about 43.5 psi to yield droplets with a volume mean diameter ranging from about 15 to about 400 microns, said gumming syrup on the surface of said confections being dried at an air temperature ranging from about 70 F to about 85 F and at an air dew point of about 10 F to about 45 F, said drum being rotated at a peripheral speed ranging from about 18 to about 93 feet per minute and the air volume blown onto the plurality of confections ranging from about 2.5 to about 20 cfm/lb of confection;
(c) spraying using an atomizer onto the surface of the product of (b) while rotating the drum of the coating pan containing the product of (b), said smoothing syrup comprised of a supersaturated solution of crystallizable sugar, non-crystallizable sugar and optionally a whitening agent while rotating the drum of the coating pan under conditions effective to uniformly coat the dried gumming syrup coating the confections, in an amount effective to smooth the coated surface of and optionally form a white coat on said plurality of confections, and subsequently drying the second component thereon; whereby the amount of crystallizable sugar present in the second syrup ranges from about 67% to about 76% (w/w) sugar and the total solids present in the syrup ranging from about 69% to about 80% (w/w), and the amount of non-crystallizable sugar being present in an amount effect to prevent the crystallization of sugar said process being effected at an air atomization pressure ranging from about 14 to about 43.5 psi to yield droplets with a volume mean diameter ranging from about 15 to about 400 microns and said smoothing syrup being dried at an air temperature ranging from about 75 F to about 90 F, at an air dew point ranging from about 10 F to about 45 F and the air volume blowing onto the plurality of confections ranging from about 2.5 to about 20 cfm/lb, said drum being rotated at a peripheral speed ranging from about 18 to about 93 fpm;
(d) optionally applying a coloring syrup onto the surface of the product of (c) completely coating said second component and coloring said irregularly shaped confections,
(e) and optionally polishing the coated confection.

In a third embodiment, the present invention is directed to a process for applying a syrup comprised of crystallizable sugar onto the surface of a plurality of bite-sized irregularly shaped confections having a non-flat base which comprises
(a) placing said plurality of irregularly shaped confections into a coating pan apparatus equipped with (1) a coating pan comprised of a rotatable drum, preferably perforated, into which the irregularly shaped plurality of confections are placed, said drum being controlled by a variable speed drive which controls the speed of the rotation of said drum; (2) an air atomizer that sprays a fine mist of each of the syrups onto the plurality of irregularly shaped confections; (3) an air inlet line and air outlet line which blows a designated air volume onto or draws air away, respectively, from the plurality of irregularly shaped confections on the drum; (4) a means of controlling the dew point of the air; (5) tanks and lines leading from said tanks which supply said syrups to said atomizer;
(b) spraying using an atomizer, onto the surface of the plurality of confections while rotating the drum, a syrup comprised of a supersaturated solution of crystallizable sugar under conditions effective to uniformly coat the confections with said syrup, and subsequently drying said syrup thereon; said syrup comprised of a crystallizable sugar ranging from about 67% to about 76% (w/w) and total solids therein in the amount of about 69% to about 80% (w/w), said syrup being dried at a temperature ranging from about 70 F to about 90 F and at an air dew point of about 10 F to about 45 F, said drum being rotated at a peripheral speed ranging from about 18 to about 93 feet per minute and the air volume blown onto the plurality of confections ranging from about 2.5 to about 20 cfm/lb of confection.

In a preferred embodiment, the syrup is the gumming syrup, the smoothing syrup or the coloring syrup, as defined herein, or a combination thereof.

Another embodiment of the present invention is directed to a process of preventing the doubling of confectionery pieces having a flat bottom resulting from sugar coating of said confectionery pieces, said process comprising forming a rounded contour on the base of said irregularly shaped confections prior to coating said confections pieces.

In a fifth embodiment, the present invention is directed to a process for sugar coating with at least two syrups a plurality of irregularly shaped confections, having a flat base which comprises:
(a) forming a rounded contour on the base for each of said confections;
(b) placing said plurality of irregularly shaped confections into a coating pan apparatus equipped with (1) a coating pan comprised of a rotatable drum, preferably perforated, into which the irregularly shaped plurality of confections are placed, said drum being controlled by a variable speed drive which controls the speed of the rotation of said drum; (2) an air atomizer that sprays a fine mist of each of the syrups onto the plurality of irregularly shaped confections; (3) an air inlet line and air outlet line which blows a designated air volume onto or draws air away, respectively, from the plurality of irregularly shaped confections on the drum; (4) a means of controlling the dew point and; (5) tanks and lines which supply said syrups to said atomizer;
(c) spraying, using an atomizer, onto the surface of the plurality of confections a gumming syrup comprised of a supersaturated solution of crystallizable sugar and a binding agent, while rotating said drum of the coating pan containing the plurality of confections under conditions effective to uniformly coat the confections with said gumming syrup and in an amount effective to bind a smoothing syrup thereon, and subsequently drying said gumming syrup thereon; said gumming syrup comprised of crystallizable sugar ranging from about 67% to about 78% (w/w) and total solids therein in the amount of about 69% to about 80% (w/w), said gumming syrup being dried on the surface of said confection at an air temperature ranging from about 70 F to about 85 F and at an air dew point of about 10 F to about 45 F, said drum being rotated at a peripheral speed ranging from about 18 to about 93 feet per minute and the air volume blown onto the plurality of confections ranging from about 2.5 to about 20 cfm/lb of confection;
(d) spraying, using an atomizer, onto the surface of the product of (c) while rotating the drum of the coating pan containing the product of (c), said smoothing syrup comprised of a supersaturated solution of crystallizable sugar, non-crystallizable sugar and optionally a whitening agent while rotating the drum of the coating pan under conditions effective to uniformly coat the dried gumming syrup coating the confection in an amount effective to smooth the coated surface of the confections and optionally form a white coat on the plurality of said confections, and subsequently drying the second component thereon; whereby the total amount of crystallizable sugar present in the smoothing syrup ranges from about 67% to about 76% (w/w) sugar and the total solids present in the syrup ranging from about 69% to about 80% (w/w), said non-crystallizable sugar being present in an amount effective to prevent the crystallization of sugar, said smoothing syrup on the surface of said confections being dried at an air temperature ranging from about 75 F to about 90 F and at an air dew point ranging from about 10 F to about 45 F and the air volume blowing onto the plurality of confections ranging from about 2.5 to about 20 cfm/lb, said drum being rotated at a peripheral speed ranging from about 18 to about 93 fpm;
(e) optionally applying a coloring syrup onto the product of (d) to cover said second component and color the plurality of irregularly shaped confections; and
(f) optionally polishing the coated confections.

In a sixth embodiment, the present invention is directed to a process for sugar coating with at least two syrups a plurality of bite sized irregularly shaped confections having a flat base which comprises
(a) forming a rounded contour on the base of each of said confections;
(b) placing said plurality of irregularly shaped confections into a coating pan apparatus equipped with (1) a coating pan comprised of a rotatable drum, preferably perforated, into which the irregularly shaped plurality of confections are placed, said drum being controlled by a variable speed drive which controls the speed of the rotation of said drum; (2) an air atomizer that sprays a fine mist of each of the syrups onto the plurality of irregularly shaped confections; (3) an air inlet line and air outlet line which blows a designated air volume onto or draws air away, respectively, from the plurality of irregularly shaped confections on the drum; (4) a means of controlling the dew point; and (5) tanks and lines which supply syrups to said atomizer;
(c) spraying, using an atomizer, a gumming syrup onto the surface of the plurality of said confections comprised of a supersaturated solution of crystallizable sugar and a binding agent, while rotating said drum of the coating pan containing the plurality of confections under conditions effective to uniformly coat the dried gumming syrup coating the confections in an amount effective to bind a smoothing syrup thereon, and subsequently drying said gumming syrup thereon; said gumming syrup comprised of crystallizable sugar ranging from about 67% to about 78% (w/w) and total solids therein in the amount of about 69% to about 80% (w/w), said process being effected at an air atomization pressure ranging from about 14 to about 43.5 psi, and said gumming syrup being dried at an air temperature ranging from about 70 F to about 85 F and at an air dew point of about 10 F to about 45 F, said drum being rotated at a peripheral speed ranging from about 18 to about 93 feet per minute and the air volume blown onto the plurality of confections ranging from about 2.5 to about 20 cfm/lb of confection;
(d) spraying, using an atomizer onto the surface of the product of (c) while rotating the drum of the coating pan containing the product of (c), said smoothing syrup comprised of a supersaturated solution of crystallizable sugar, non-crystallizable sugar and optionally a whitening agent under conditions effective to uniformly coat the dried gumming syrup coating the confections in an amount effective to smooth the coated surface of said confections and optionally form a white coat on said plurality of confections, and subsequently drying the second component thereon, whereby the amount of crystallizable sugar present in the smoothing syrup ranges from about 67% to about 76% (w/w) sugar and the total solids present in the smoothing syrup ranging from about 69% to about 80% (w/w), said smoothing syrup being applied at an air atomization pressure ranging from about 14 to about 43.5 psi to yield droplets with a volume mean diameter ranging from about 15 to about 400 microns, said smoothing syrup being dried at an air temperature ranging from about 75 F to about 90 F, at an air dew point ranging from about 10 F to about 45 F and the air volume blowing onto the plurality of confections ranging from about 2.5 to about 20 cfm/lb, said drum being rotated at a peripheral speed ranging from about 18 to about 93 fpm;
(e) and optionally coloring the product produced in (d); and
(f) optionally polishing the plurality of coated confections.

A further embodiment of the present invention is directed to a process for sugar coating a plurality of bite sized irregularly shaped confections having a flat base which comprises rounding out the base sufficiently so that a bulge can be seen with the naked eye in the base, and substantially uniformly sugar coating the confections, and optionally polishing the plurality of confections.

An eighth embodiment of the present invention comprises a sugar coated irregularly shaped confection.

A ninth embodiment is also directed to the coated confections prepared by any of the processes described herein.

Another embodiment is directed to the process for sugar coating with at least two syrups a plurality of bite sized irregularly shaped confections having a non-flat base which comprises
(a) placing said plurality of irregularly shaped confections into a coating pan apparatus equipped with (1) a coating pan comprised of a rotable drum into which the irregularly shaped plurality of confections are placed, said drum being controlled by a variable speed drive which controls the speed of the rotation of the drum, (2) an air atomizer that sprays a fine mist of each of the syrups onto the plurality of irregularly shaped confections; (3) an air inlet line and air outlet line each extending from outside of the coating pan apparatus into the interior of the coating pan which blows a designated air volume onto or draws air away from, respectively the plurality of irregularly shaped confections, said air blowing onto the drum having a designated range of dew points; and (4) tanks and lines leading from said tanks which supply syrups to said atomizer;
(b) spraying, a gumming syrup comprised of a supersaturated solution of crystallizable sugar and a binding agent onto the surface of the plurality of confections through an atomizer while rotating said drum of the coating pan containing said plurality of confections under conditions effective to uniformly coat the confections with said gumming syrup in an amount effective to bind a smoothing syrup thereon, and subsequently drying said gumming syrup thereon, said gumming syrup comprised of a crystallizable sugar ranging from about 67% to about 78% (w/w) and total solids therein ranging from about 69% to about 80% (w/w), said gumming syrup being dried at a dew point ranging from about 10 F to about 45 F, said drum being rotated at a peripheral speed ranging from about 18 to about 93 feet per minute and the air volume blown onto the plurality of confections ranging from about 2.5 to about 20 cfm/lb of confection;
(c) spraying said smoothing syrup comprised of a supersaturated solution of crystallizable sugar and non-crystallizable sugar onto the surface of the product of (b) through an atomizer while rotating said drum of the coating pan containing the product of (b) under conditions effectively to uniformly coat the dried gumming syrup coating the confections in an amount effective to smooth the coated surface of the product of (b), and subsequently drying the second component thereon, said non-crystallizable sugar being present in an amount sufficient to prevent the crystallization of the sugar in the smoothing syrup onto the surface of the product of (b) whereby the total amount of crystallizable sugar present in the smoothing syrup ranges from about 67% to about 76% (w/w) sugar and the total solids present in the syrup ranging from about 69% to about 80% (w/w), said smoothing syrup being dried on the surface of the resulting product at a dew point ranging from about 10 F to about 45 F, and the air volume blowing onto the plurality confections ranging from about 2.5 to about 20 cfm/lb, said drum being rotated at a peripheral speed ranging from about 18 to about 93 fpm; and
(d) optionally polishing the product of step (c).

A further embodiment is directed to the process for sugar coating with at least two syrups a plurality of irregularly shaped confections having a flat base which comprises:
(a) forming a rounded contour on the base for each of said confections;
(b) placing said plurality of irregularly shaped confections into a coating pan apparatus equipped with (1) a coating pan comprised of a rotable drum into which the irregularly shaped plurality of confections are placed, said drum being controlled by a variable speed drive which controls the speed of the rotation of the drum, (2) an air atomizer that sprays a fine mist of each of the syrups onto the plurality of irregularly shaped confections; (3) an air inlet line and air outlet line each extending from outside of the coating pan apparatus into the interior of the coating pan which blows a designated air volume onto or draws air away from, respectively the plurality of irregularly shaped confections said air blowing onto the drum having a designated range of dew points; and (4) tanks and lines leading from said tanks which supply syrups to said atomizer;
(c) spraying a gumming syrup comprised of a supersaturated solution of crystallizable sugar and a binding agent onto the surface of the plurality of confections through an atomizer while rotating said drum of the coating pan containing said plurality of confections under conditions effective to uniformly coat the confections with said gumming syrup in an amount effective to bind a smoothing syrup thereon, and subsequently drying said gumming syrup coating said confections, said gumming syrup comprised of a crystallizable sugar ranging from about 67% to about 78% (w/w) and total solids therein ranging from about 69% to about 80% (w/w), said gumming syrup being dried at a dew point ranging from about 10 F to about 45 F, said drum being rotated at a peripheral speed ranging from about 18 to about 93 feet per minute and the air volume blown onto the plurality of confections ranging from about 2.5 to about 20 cfm/lb of confection;
(d) spraying said smoothing syrup comprised of a supersaturated solution of crystallizable sugar and non-crystallizable sugar onto the surface of the product of (c) through an atomizer while rotating said drum of the coating pan containing the product of (c) under conditions effectively to uniformly coat the dried gumming syrup coating the product of (c) in an amount effective to smooth the coated surface of the product of (c), and subsequently drying the smoothing syrup thereon, said non-crystallizable sugar being present in an amount sufficient to prevent the crystallization of the sugar in the smoothing syrup, whereby the total amount of crystallizable sugar present in the smoothing syrup ranges from about 67% to about 76% (w/w) sugar and the total solids present in the syrup ranging from about 69% to about 80% (w/w), said smoothing syrup being dried on the surface of the resulting product at a dew point ranging from about 10 to about 45 F, and the air volume blowing onto the plurality confections ranging from about 2.5 to about 20 cfm/lb, said drum being rotated at a peripheral speed ranging from about 18 to about 93 fpm; and
(e) optionally polishing the product of step (d).

A further embodiment is directed to the products produced by any of the aforementioned processes.

### BRIEF DESCRIPTION OF THE DRAWINGS

The accompanying drawing, which is incorporated in and constitutes a part of the specification, provides an embodiment of the present invention, and together with the general description given herein serve to illustrate the present invention.

FIG. 1 exemplifies a product, viz, a Hershey's Kisses® chocolate product which is coated with sugar in accordance with the process described herein.

### DETAILED DESCRIPTION OF THE INVENTION

The term “confection” or “confectionery product” or synonym thereto as used herein refers to a sweet candy made with sugar which has a fat based center having a melting point above 85 F. The confection can be combined with other food solids, such as nut solids or milk solids or cocoa solids or pieces of fruit, wafer, cookie, caramel, nuggets or other foods commonly found in confections or combination thereof. The preferred confection is chocolate, which optionally may contain any one or more of these additional components.

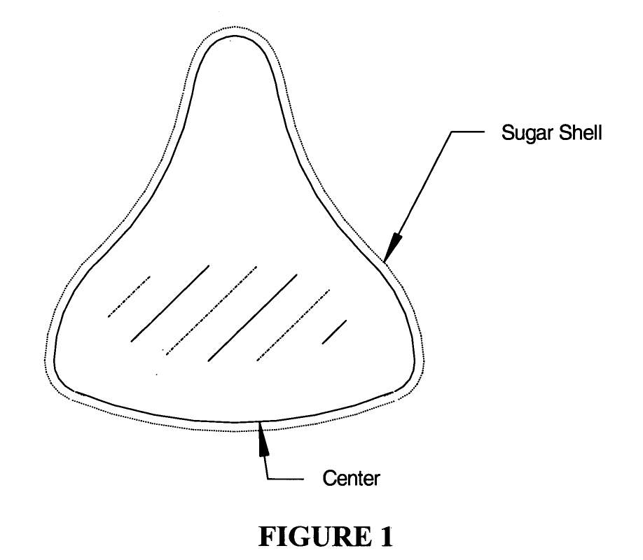

As used herein, the term “irregularly shaped confection” or synonym thereto refers to a confection having at least one tip thereon or a protrusion thereon which tapers to a point. The confection can be any shape, as long as it contains at least one point thereon. Thus, it can be circular-like or oval-like which tapers at one end with a point, or it can be rectangular or square with at least one point thereon, or it can be polygonal, e.g., pentagonal, hexagonal, octagonal, decahedral and the like, with at least one point thereon, or it can be cylindrical which tapers at one end with at least one point thereon, and the like or it can be conical or conical-like. The point, however, may be rounded, as depicted in FIG. 1. It is preferred that the diameter of the point be no greater than 10% of the length (or width) of the base if the base is flat and if the base is rounded, no greater than 10% of the diameter. The preferred shape is conical. Examples of such confections include a bell shaped confection which has one end tapered to form a tip, a star shaped confection containing at least three points thereon, a starfish shaped confection, and the like. A preferred example of such product is a Hershey's Kisses® chocolate, which is the preferred shape and which is shown in FIG. 1. It has been described as a conical bite-sized piece of chocolate. It also has been described as a chocolate in the shape which evolves from a single pointed tip flowing downward and outward and expanding through three dimensions towards curved shoulders down to a rounded bottom.

Moreover, the irregularly shaped confection, e.g., chocolate, is bite-sized. By “bite-sized”, it is meant that the size of each individual confection which is to be coated as well as the confection coated in accordance with the present invention, is small enough to be eaten in a single mouthful (in an average adult mouth). It is preferred that the height of the confection is no longer than about 30 mm, the width is no longer than about 30 mm, and more preferably each of the height, width and length thereof independently ranges from a size larger than 0 to about 25 mm and more preferably from about 5 to about 20 mm. Moreover, the radii of the curvature extending from the tip to the “shoulders” is a key attribute related to the Hershey Kisses® chocolate described as the preferred shape within this application. This curvature is defined by an arc radius of approximately 8 to about 12 mm. Maintaining this curvature post application of the sugar shell components was a key decisive factor which the inventors were to able to achieve by the process described herein. In addition, the pointed tip of the preferred shape is defined as having two arc radii of approximately about 1 to about 2 mm and about 3 to about 5 mm, respectively. The ratio of the tip point diameter to primary arc radius is furthermore described as ranging from about 0.3 to about 0.6. Thus, the tip of the Hershey's Kisses® chocolate is not a singular point.

The term “uniform” signifies that the coating has an overall constant thickness.

The terms “chocolate” and “chocolate confections” are used interchangeably. It refers to a chocolate or chocolate composition having a temperable fat phase. The term is intended to include all chocolate and chocolate-like compositions that contain at least one cocoa or cocoa like component in the temperable fat or temperable fat-like phase. It additionally contains a nutritive carbohydrate sweetener, or a sugar substitute or sugar equivalent or combination thereof and may additionally contain an emulsifier and/or bulking agent. The term is intended, for example, to include standardized and non-standardized chocolates, including chocolates with compositions conforming to the U.S. Standards of Identity and compositions not conforming to the U.S. Standards of Identity, including, but not limited to, dark chocolate, milk chocolate, sweet chocolate, semi-sweet chocolate, buttermilk chocolate, skim-milk chocolate, white chocolate, non-standardized chocolate and the like. The fat phase of the chocolate used in the present invention includes the fats normally found in chocolates, including but not limited to cocoa butter (and/or chocolate liquor), milkfat, anhydrous milk fat and other fats or a mixture of cocoa butter with these other fats. See Minifie, “Chocolate Cocoa and Confectionery: Science ad Technology,” 2^{nd} ed. AVI Publishing Co., Inc, 2^{nd} Ed., the contents of which are incorporated by reference.

In the United States, chocolate is subjected to a standard of identity established by the United States Federal Food and Drug Administration. Definitions and standards for the various types of chocolate are well established in the United States. Non-Standardized chocolates are those chocolates which have compositions which fall outside the specified ranges of the standardized chocolates. Examples of non-standardized chocolates result when the nutritive carbohydrate sweetener is replaced, partially or completely, or when the cocoa butter or milk fat is replaced partially or completely, or when the chocolate contains components that have flavors that imitate milk fat or cocoa butter when there are other additions or deletions in the chocolate that do not fall within the parameters of the USFDA standards of identity of chocolate or combinations thereof.

The nutritive carbohydrate sweetener, with varying degrees of sweetness, are those typically used in the art. They include, but are not limited to, sucrose, dextrose, fructose, lactose, maltose, glucose syrup, molasses and the like. The nutritive carbohydrate sweetener, preferably sucrose, is present in the chocolate as crystals or particles. However, the chocolate confection that is coated may contain sugar substitutes or equivalents which partially replace the nutritive carbohydrate sweetener. Examples include bulking agents, sugar alcohols (polyols) or high potency sweeteners or combinations thereof. The high potency sweeteners include aspartame, cyclamate, saccharin, acesulfame-K, neohesperidin, dehydrochalcone, sucralose, alitame, stevia sweeteners, glycyrrhizin, thaumatin and the like. Examples of sugar alcohols are those typically used in the art and include sorbitol, maninitol, xylitol, maltitol, isomalt, lactitol, and the like. The chocolate may contain bulking agents used in the art, such as polydextrose, cellulose and/or its derivatives, maltodextrin, gum arabic and the like. In addition, the chocolate may contain emulsifiers, used in the art, including lecithin, fractionated lecithin, which may be enriched in either phosphatidyl cholines or phosphatidyl ethanolamines or both, mono- and diglycerides, diacetyl tartaric acid esters of mono-diglycerides (DATEM), mono-sodium phosphate derivatives of mono and diglycerides, edible fats or oils, sorbitan monostearate, hydroxylated lecithin, fatty acid esters of glycerol and propylene glycol, polyglycerol esters of fatty acids, propylene glycol mono- and diester of fats and fatty acids and the like.

The confections are prepared by art-recognized techniques known in the art.

Typically, the carbohydrate sweetener is combined and mixed with cocoa butter and/or chocolate liquor, and/or other fat such as milk fat and any other ingredients mentioned hereinabove to form a paste. Next the paste formed in the mixing step is refined. The refined paste is conched wherein flavors, emulsifiers and/or additional cocoa butter may be added. The resulting conched product is standardized, wherein additional emulsifiers and/or cocoa butter are added to adjust the viscosity to the desired specification. The standardized product is next subjected to tempering, the process of inducing satisfactory crystal nucleation of the liquid fat in the chocolate. The final step of the chocolate making process is forming wherein the chocolate product is made into the desired shape. In the forming process, the tempered chocolate product may be deposited into molds, into forming rolls, or onto a belt containing the desired bottom shape, allowed to cool and then removed.

Although confectionery products often utilized have flat bottoms, the confectionery products of the present invention utilized for coating do not have flat bottoms. Instead, the bottom base of the confections bulges slightly inward or outward. The present inventors have found that a slight bulging of the base (inward or outward) prevents and/or significantly retards the sticking of the various pieces into larger agglomerations in the first coating phase of the process. In this way, by causing an inward or outward bulge of the base, each individual piece of the formed product can be coated in accordance with the present invention. It is preferred that the bottom base of the confection product is concave (arched in or rounded in) or convex (curved or rounded out like the exterior of a sphere or circle), and more preferably the bottom is convex.

The confection centers that are sugar coated are manufactured with rounded bottom using techniques known in the art. Typically this is the last step in the process of making the confectionery center. For example, prior to being sugar coated, the confections are subjected to a process that makes the bottoms thereof round. For instance, the confection centers may be liquefied and extruded and made round by supplying sufficient force to the liquid confectionery center by conventional means. It is preferred that the liquid confectionery center is placed into a mold. For example, in the case of chocolate, at the end of the forming step, after the tempered chocolate is subjected to the forming step, the bottom is extruded and made round by applying sufficient force to the liquid mold utilizing conventional means. For example, in a preferred embodiment, a stamping head is used with force sufficient to form a rounded bottom which is convex. Alternatively, hot tempered chocolate may be deposited into a mold which may have a non-flat bottom, for example, rounded bottom. In either method, after the tempered chocolate is deposited and the bottom base is rounded, the uncoated tempered chocolate product is allowed to cool and to solidify. After solidification, the tempered chocolate molded product is removed from the mold using conventional techniques known in the art.

Alternatively, a molding process by means of drop rolling may be employed to manufacture the irregularly shaped confectionery centers of the desired shape. Drop rolling is a customary process of forming the confectionery centers by means of using a pair of identical cylindrical rolls (drop rolls) fashioned in parallel orientation and nearly touching each other. The rolls are typically mounted on the horizontal plane. Matching bi-sectal impressions of the desired confectionery center are carved into the circumference of each roll. The bi-sectal impressions line up with each other as the rolls are turned to momentarily form a complete three dimensional shape of the confectionery center. The confectionery center material is introduced into the gap between each drop roll and drawn into each impression as the roll is turned, creating the three dimensional form of the impression. The drop rolls are normally chilled with low temperature coolant media to quickly “freeze” the center material. As the drop rolls turn, the center material is removed from the roll as a complete three dimensional form.

Typically, the confectionery center is made into a round bottom as the last step of preparing the confectionery center.

The formed product is next subjected to coating. In accordance with the present invention, it is preferred that a plurality of irregularly shaped confections are coated at one time in a coating pan apparatus that is conventionally used in the arts, especially the confectionery art and most especially the pharmaceutical arts. The coating pan system preferably has a perforated pan or a drum which revolves in a manner similar to a standard clothes dryer. The system includes an air-atomization spray gun which is inserted into the center of the drum for spraying a fine mist of coating material. The plurality of confection centers is typically introduced into the cylindrical pan, which is typically rotated during the process, causing the confections to tumble. A brief description of some basic parts of the typical pan coating machine utilized is outlined hereinbelow. Variations thereof can also be utilized as a substitute. Thus, the present invention is not limited to the specific description herein.

The plurality of irregularly shaped confections with a rounded base are conveyed to the coating pan by appropriate conveying means and are deposited onto a rotatable coating pan. It is in the rotating pan in which the plurality of irregularly shaped confections are sprayed with coating syrups as described hereinbelow and dried until the final hard coating is formed. The coating pan used may be any one of the standard types, and it may be and is preferably modified by insertion of baffles, e.g., 3 to 4 or more baffles, to insure adequate tumbling of the confections during the coating operation. The coating pan can be any shape, e.g., square, rectangular, circular, and more preferably cylindrical or pear shaped (e.g., Groen Pear Coating Pan Stainless Steel, Dwg C-58205), or an angular shaped coating pan (e.g., Groen Angular Coating Pan, Stainless Steel Dwg C-5669), or a doughtnut shaped coating pan (e.g., Colton Doughnut Coating Pan No. 46), or a hexagonal shaped coating pan (e.g., Colton Hexagonal Coating Pan, Modified No. 16). The baffles attached to the interior of the coating pan are preferably placed about 5 inches to about 10 inches from the bottom center of the pan located substantially at the position of the motor housing shaft which rotates the drum and then extends from about 5 to 10 inches from its periphery. The numbers of baffles present may be varied. Normally, 3 or 4 equidistant baffles are adequate. However, the number may be increased or decreased. The baffles may be tapered toward the center of the pan and may be designed with a gradual rise from the bottom to the periphery of the pan. Angular or curved baffles may also be used. The baffles are comprised of non-reactive materials, e.g., stainless steel, copper, polyethylene, polypropylene, Teflon, solvent resistant rubber and the like. The baffles facilitate mixing of the confection products and a relatively even distribution of the coating syrups on the pieces of confection. If the coating pan contains baffles, they are oriented at an angle so as to enable an optimum syrup distribution through a complete movement of products on the coating pan. Preferably, they are sloped in the direction of the motion of the coating pan.

The coating pan is preferably perforated, with a multitude of airholes smaller in size than the size of confections which are placed on the drum. It is preferred that the drum is relatively evenly perforated, to allow maximum exposure to drying air.

It is preferred that the depth of the coating pan is rather low. The depth is preferably sufficiently low to allow maximum exposure to spraying guns or nozzles, thereby providing a better syrup distribution on the chocolate and to achieve a faster drying cycle. The depth is also preferably sufficiently low so as to avoid product damage due to weight from above.

The coating pan is rotated by a rotating mechanism of a conventional type. The rotating mechanism is preferably a drive rotatably driven by a motor so that the drum rotates substantially around a horizontal axis in a horizontal plane. This results in mainly a rolling movement of the plurality of confections on the coating pan. The rotating mechanism can rotate the coating pan at various speeds. Although the rotation can be set to specific speed settings, it is preferred that the speed of the rotating coating pan vary as continuous from 0 to a maximum setting, usually about 12 rpm or higher.

The coating pan apparatus is equipped with air intake conduits and air outtake conduits. The air inlet conduit and the air outlet conduit may be tubing, hosing, piping or any conventional means used in the art. If it is a pipe, it is preferred that it is comprised of stainless steel or aluminum. The air conduits are preferably integrally provided with the rotary drum. The air conduits or ducts are present at predetermined intervals in the circumferential direction. The air intake conduit is preferably connected by connecting means to a blower. The air intake conduit extends from the exterior of the coating pan apparatus through the coating pan apparatus and terminates at a position that is external to the coating pan apparatus from which air can be blown onto the irregularly shaped chocolates in the coating pan. The blower which is one that is typically used in the art is connected to the air inlet conduit on the exterior of the coating pan apparatus. The blowing air dries the syrup coats that are applied onto the confections of irregular shapes, as described herein. The inlet conduit may be one conduit or it may have branches emanating therefrom which leads to various parts of the coating pan apparatus. Moreover, more than one pipe or branch may empty air onto the plurality of irregularly shaped confections in the coating pan. Further, the air inlet conduit or its branches may be connected to a heating means, such as heater. For example, a heating jacket or electrical heater mechanism may be attached to the air inlet conduit or any of its branches to warm or heat the incoming air to the desired temperature.

The dew point of the inlet air that enters the coating pan apparatus is within the designated values described herein. Obviously, prior to entering the coating pan apparatus, the dew point of the inlet air is measured by measuring means known in the art. If the dew point of the air is within the specified range, it is fed into the air intake conduits as described herein. If, however, the dew point is outside of the ranges indicated herein, then it is subjected to dehumidifying means known in the art, such as a dehumidifier or an air conditioner, if the dew point is too high, until the dew point is within the range designated herein. However, if the dew point is too low, then moisture can be added to the air by conventional techniques until the dew point is in the range indicated herein. Other examples of means of controlling the dew point of the air is described in U.S. Pat. Nos. 5,762,690; 5,205,485; 5,118,327; and 6,527,836, the contents of all of which are incorporated by reference. Alternatively, the dew point controlling apparatuses are present within the coating pan apparatus and the conduits of the incoming air leads to, enters and emanates from these apparatuses so that the incoming air passes therethrough.

The inlet air is fed into the coating pan by various means. In one embodiment, the air is fed into the coating pan from the side through flexible tubes. In this way, the inlet air can be directed to any spot in the coating pan. In another embodiment, the air is delivered from behind the coating pan through the air inlet conduit, e.g., a pipe which is bent down into the coating pan from above at an angle, such as a right angle. A flexible hose which can be removed during the loading or unloading of the coating pan is connected to the air pipe and can be used to divert the incoming air to any spot on the coating pan.

In another embodiment, the air is fed into the coating pan from the front through a pipe protruding into the coating pan. The pipe is located horizontally through the coating pan above the area where the plurality of the irregularly shaped chocolates are positioned. The pipe contains slots running along the entire length. The air is fed into the pipes and blown onto the confections through the slots.

The air inlet conduit preferably contains a filter at the exterior end of the pan coating apparatus. The filters utilized are the ones commonly used in the art. It is preferably a submicron particulate filter which prevents the flow of particles greater than a micron e.g., through the inlet conduit.

The outlet conduit is connected to an external outside pump of the coating pan apparatus by a connecting means, such as tubing, hoses or pipes. The outlet conduit removes the moisture from the syrups deposited on the irregularly shaped chocolates located in the coating pan to promote drying. The outlet conduit preferably does not come in contact with the air entering the pan coating apparatus through the inlet conduit. It is preferred that the air outlet conduit is fitted to or is located just below the coating pan. In this arrangement, the drying air, when extracted through the air outlet conduit is forced through the coating pan through the perforations. Accordingly, the plurality of chocolates on the coating pan are subjected to a more intensive jet of drying air than if the outlet air is discharged from a separate position. This arrangement tends to maximize the drying of the confections by pulling the moisture directly from the confections on which the various syrups are applied. It is to be noted that any dust that may form during the coating process and any smaller particles may also be removed by the air stream. It is preferred that the drum is regularly perforated to allow optimum drying of the products.

The syrups are sprayed onto the coated confections from a series of spray nozzles positioned inside the coating pan. Each syrup material is provided from a tank or container which is typically positioned adjacent to the coating pan.

The syrup material is transported through a pipe to the spray nozzles. Each conduit or tank container or both have a valve which opens or closes, permitting or preventing, respectively, the syrup material from entering the coating pan.

In a preferred embodiment, the spraying is performed utilizing an air atomizing spray machine normally used in the arts. The machine is equipped with a binary nozzle which facilitates airborne spraying in which one hose delivers compressed air to the atomizer whereas the other hose carries the coating syrup from the tank or container containing syrup to the air atomizer. In the present process, air atomization aids with the dispersion of the syrup in a very thin layer on the product surface. The air atomization is at a sufficient pressure so as to reduce the temperature of the syrup and prevent melting or wearing of the tip of the confectionery center.

It is preferred that there are separate hoses carrying each of the coating syrups from the tank or container, containing each syrup to the air atomizer. For example, there is one for the first syrup (gumming syrup), and one for the second syrup (the smoothing syrup). If a third syrup such as a coloring syrup is utilized, then there should be a separate hose for the coloring syrup. Each hose has a valve that opens or closes, thereby permitting or preventing respectively the flow of syrup to the atomizer. When the valve to the hose leading to a syrup container is open, the other valves are closed, so that one syrup enters the atomizer at a time. The spray nozzles are located inside the coating pan. When the trigger is pressed (i.e., the gun is opened), the syrup is discharged and is atomized, i.e., sprayed, by the air that is released simultaneously. The bores of the spray nozzles can be any diameter or shape that is used in the art, preferably nozzles with a diameter ranging from about 0.5 to about 3 mm and more preferably, from about 1.1 to about 1.9 mm are used, and most preferably from about 1.3 to about 1.7 mm in diameter, and said nozzles in combination with the air atomization pressure, deliver syrup droplets with a volume mean diameter of less than about 600 microns and more preferably from about 1 micron to about 500 microns, and even more preferably from about 15 microns to about 400 microns and most preferably, droplets with a volume mean diameter ranging from about 20 to about 100 microns.

The spray from the atomizer is applied to the confection at an angle sufficient to coat the confectionery products. Preferably, the spray nozzles spray at an angle between about 40° and about 90°. The spray nozzles sprays the syrup onto the plurality of confections in such a way that the whole surface is uniformly coated with syrup. There is used as the spray nozzle a known type of nozzle normally used in air atomizing spraying, air being fed laterally to the nozzle through the flexible hose or pipe. Of course, instead of air, another suitable gas may be used. An example of a spray nozzle that may be used is described in U.S. Pat. No. 3,470,831, the contents of which are incorporated by reference.

As described hereinbelow, the syrups that flow through the hose or pipe leading to the atomizer are hot. The atomizing sprayer maintains the temperature of the syrups through the tip of the nozzle. Then, atomization assists in cooling down the temperature of droplets (fine mist) of the syrup before they hit the confectionery centers.

Finely atomized spray droplets produce very fine droplets which remain tacky throughout the transit distance and time between the nozzle and the surface of the confections. These droplets bind or attach to the surface of the coated centers, and smear or spread slightly. Throughout the spray duration, repeated passes of the confection through the spray application leads to very uniform buildups of the syrup onto the tumbling bed of confections. Because the process generates a fine mist or fog of syrup particles targeted at the rotating bed of confections, the centers are coated relatively quickly with the least amount of tumbling.

In an embodiment, the end of the atomizing nozzle may include a fluid cap and/or an air cap. The fluid cap orifice diameter regulates, limits and controls the maximum flow rate of the spray droplet spraying from the nozzle.

It is to be noted that the spraying can be, and is preferably, alternatively started and stopped to allow layers of coating to dry onto the surface of the confections.

The atomizing air spray rate can vary greatly and is influenced by various factors, including the viscosity of the syrup, the surface tension and geometry of the nozzle tip and spray pattern. It should be appreciated that spray nozzle parameters in the various embodiments of the present invention (e.g., spray rate, atomizing air, nozzle tip and temperature) can be modified to provide a uniform distribution of the fine mist of syrup droplets which remain hot and tacky during the transit from the nozzles to the surface of the confectionery centers.

In the present process, the heated syrup is sprayed onto the confections to form a coat therein. The spray is generated by passing the syrup through a spray head which causes pressure loss, thus contributing to the evaporation of the moisture by flash evaporation and thereby effectively increasing the concentration of the solute in the droplets. The evaporative cooling effect and increased ratio of solute to solvent results in a spray condition where, according to the phase diagram of the sucrose water system, crystal formation commences.

It has been found that the spraying step has an influence in the resulting topical coatings. Decreased droplet size and increased droplet fall time have a beneficial effect on crystallization. Compressed air forces the spraying liquid through a pressure proof hose or pipe into the spray gun. The air is the carrier of the syrup. Of course, instead of air, another suitable gas may be used. Its pressure is set to a pressure sufficiently high to coat the confection but sufficiently low so that the pointed tip of the confection is not significantly broken off or rounded. The preferred air atomizing pressure of the spray gun ranges independently from about 14 to about 43 psi for each of the syrups (the first syrup, or gumming syrup, the second syrup or smoothing syrup and if there is a third syrup, the coloring syrup, and for any additional syrups utilized) and more preferably from about 29 to about 36 psi for each of the syrups. It should be understood that the air atomization pressure for each syrup is independent of the other, that is, the air atomization pressure for applying the gumming syrup may be the same or different from the air atomization pressure for applying the smoothing syrup and the latter may be the same or different from the air atomization pressure for applying any additional syrups such as the coloring syrup. Similarly, the air atomization pressure for applying the smoothing syrup may be the same or different from the air atomization pressure for applying any other syrup, e.g., if it is utilized, the coloring syrup and as indicated hereinabove, it may be the same or different from the air atomization pressure for applying the gumming syrup. Similarly, as indicated hereinabove, the air atomization pressure for applying the coloring syrup, if it is utilized, may be the same or different from the air atomization pressure for applying the gumming syrup and may be the same or different from the air atomization pressure for applying the smoothing syrup. However, in a preferred embodiment, the atomization pressures for applying each of the syrups in the process described herein are about the same.

The hose carrying the spray solution is connected to the three tanks or container holding each of the three spraying syrups. The tanks and/or the hose is equipped with a valve, which may be automated to control the flow of each syrup into the coating apparatus. In accordance with the present invention, each syrup utilized in the present process is a supersaturated solution of sugar. Thus, each material is maintained at an elevated temperature, both in the container or holding tank and throughout the passageway through the conduit or pipe to the coating pan. They are maintained at elevated temperatures to prevent the solids in the syrups from precipitating or crystallizing out of solution prior to being sprayed. For this purpose, a heated water jacket or electrical heater type mechanism is utilized to maintain the syrup in each tank or container at an elevated temperature, preferably above the melting temperature of the confectionery center. Preferably, the temperature of each of the syrups is maintained at a temperature ranging from about 140 F to about 180 F and more preferably from about 160 F to about 170 F. In addition, a heating jacket or electrical heater mechanism may be used to maintain each syrup in the conduit at an elevated temperature. In this regard, heated water jacket systems and electrical heating systems conventionally known in the art may be used. Typically, the heated jackets are heated with hot water, although steam or heated oil could be used if the elevated temperature created by these other systems do not degrade the syrup material.

As described herein, at least two and preferably three different syrups are applied to the plurality of the irregularly shaped confection products on the coating pan. Each of the syrups contain sugars. The term “sugar” as used in the coating refers to a sugar normally used in coating confections. It is a carbohydrate, preferably a monosaccharide or disaccharide. Each sugar unit includes altoses or ketoses containing 3-6 carbon atoms. The preferred sugar is sucrose. In general, it is preferred that the various syrups utilized contain a supersaturated solution of sugars. In all of the syrups utilized in the process, the amount of sugar independently ranges from about 60% to about 85% by weight of the syrup and more preferably from about 65% to about 80% by weight of the syrup. However, the amount of sugar in each syrup utilized may vary. It is dependent on a number of factors, including the size of the confection, the quantity of confection to be coated, the air volume, the coating pan and the like.

Using too high a concentration of sugars in the syrups for any individual layer can create a rough coating texture Too small a concentration of sugars in the syrups makes the drying time increase, causing an inefficient process and unnecessarily worn pieces. Furthermore, if too high a quantity of syrup is applied, the excess solution would once again increase drying time, cause unnecessarily worn tips, and may actually diffuse into the previously dried coating layers, causing the pieces to lose luster in the final product. In addition, the solution may adhere to the walls of the coating pan, thereby increasing the thickness of the wall. Too small a quantity of syrup can create a rough coating texture.

Besides the sugar, the syrup applied in the first phase, i.e., the gumming syrup, contains a film forming agent which is present in amounts sufficient to impart protectiveness to the syrup so that when applied to the confection, the second component can adhere thereto. Thus, the film forming agent is present in binding effective amount. The film forming agent used is one that is normally used in syrups for this purpose. Examples include glucose syrup (e.g., 0.5 to 4% w/w), gum arabic, xanthan gum, gelatin, gum tragacanth, maltodextrin and the like. The preferred adhesive is gum arabic.

In the gumming syrup, it is preferred that the amount of sugar present ranges from about 67% to about 78% by weight of the syrup and more preferably from about 70% to about 74% of the syrup. It is also preferred that the amount of adhesive, e.g., gum arabic, ranges from about 3% to about 5% (w/w) of the syrup and more preferably from about 2% to about 4% by weight.

Other additives which are discussed hereinbelow may also be present. The preferred amount of solids present in the gumming solution ranges from about 69% to about 80% by weight of the syrup and more preferably from about 74% to about 77% by weight of the syrup.

The remainder of the syrup is water. It is preferred that water is present in amounts ranging from about 20% to about 31% by weight of the syrup and more preferably from about 23% to about 26% by weight of the syrup.

The quantity of each layer of component may vary with the type of syrup applied. Preferably, the first component, i.e. the gumming syrup, adds from about 6.5% to about 8.1% and more preferably from about 7.0% to about 7.5% to the weight of the uncoated confection.

The smoothing syrup smoothes out the surface of the chocolate. It optionally contains a whitener.

A whitener is not necessary if the final product is not colored, i.e., if a third layer or coat for coloring the confection is not applied. However, if the final product is colored, even if it is a uniform white color, the whitener is also present in the second syrup to whiten the product for preparation of color. The whitener acts as a primer, facilitating the adhesion of the coloring coat onto the second layer. In a preferred embodiment, the product is colored and a whitening agent is present in the smoothing syrup. The whitening agent is present therein in amounts sufficient to uniformly whiten the confection, thus prepared by the process described herein.

As with the first syrup, a supersaturated solution of sugar is present in the smoothing syrup. Preferably, the sugar is present in amounts ranging from about 67 to 76% and more preferably from about 70% to about 74% by weight.

The smoothing syrup also is comprised of a non-crystallizing agent, which is present in amounts sufficient to retard the crystallization of sugar on the coat. As described above, the function of the second layer is to smooth out the surfaces. This is effected if the crystallization of sugar is prevented or significantly retarded. Examples of the non-crystallizing agent include glucose syrup or corn syrup or sorbitol and the like. The preferred non-crystallizing agent used in the smoothing syrup is corn syrup. Preferably, it is present in the smoothing syrup in amounts ranging from about 1% to about 5% and more preferably from about 1.0% to about 3.0% by weight.

The smoothing syrup is also preferably comprised of a whitening (brightening) agent. As described hereinabove, it is utilized if the confection is to have a color coat. It is present in amounts effective to whiten the appearance of the coated product. Examples of the brightening agent include titanium dioxide, calcium carbonate and the like. The preferred brightener used in the smoothing syrup is titanium dioxide. Preferably, the whitening agent is present in the smoothing syrup in amounts ranging from about 1% to about 5% and more preferably from about 1.3% to about 3.5% by weight of the syrup. The smoothing syrup contains water in amounts ranging from about 20% to about 31% by weight of the syrup and more preferably from about 27% to about 29% by weight of the syrup.

Other additives, which are discussed herein below may also be present. The preferred amount of solids present in this smoothing syrup ranges from about 69% to about 80% by weight and more preferably from about 71% to about 75% by weight of the syrup.

Preferably, the amount of smoothing syrup added in the second phase to the confection ranges from about 11.5% to about 13.3% and more preferably from about 12.2% to about 12.7% of the total weight of each of the uncoated chocolate.

It is preferred that a third layer or coat is added onto the confectionery center. More specifically, it is preferred that the confectionery center is coated with a coloring layer using techniques known in the art. In a more preferred embodiment, the confectionery center is colored using a coloring syrup known in the art by applying a coloring effective amount of a coloring syrup onto the confection which has been coated with both the gumming syrups and the smoothing syrups containing the smoothing agent and the whitening agent. In the most preferred embodiment, a third syrup, the coloring syrup, is applied to the surface of the confection. It is applied to the confection over the dried smoothing syrup. As with the other syrups, the coloring syrup also contains sugars and preferably a supersaturated solution of cyrstallizable sugar. Preferably, the amount of sugar solids present in the coloring syrup ranges from about 67 to about 75% of the syrup.

However, it also contains a coloring agent known in the art that is conventionally used in coloring confections. Examples of colorants include: FD+C Yellow 5 lake, FD+C Yellow 6 lake, FD+C Blue 1 Lake, FD+C Blue 2 Lake, FD+C Red #40 Lake and the like. In addition, pure dye colorants such as: FD+C Blue 1 dye and FD+C Red 40 dye, FD+C Red 3 dye, FD+C Yellow 5 dye, FD+C Yellow 6 dye, FD+C Blue 2 dye and the like may be used. The coloring agents are present in coloring effective amounts to color the third coating sufficiently for the color to be perceived with the naked eye. Preferably, the coloring agent is present in the coloring syrup in amounts ranging from about 1% to about 6% and more preferably from about 2% to about 5% by weight of the syrup. The colorants, e.g., FD&C Dye coloring agents, are present in coloring effective amounts to uniformly color the third coating sufficiently so that the color, including white, can be perceived with the naked eye. Preferably, the coloring agent is present in the third syrup in amounts ranging from about 0.1% to about 0.6% and more preferably from about 0.2% to about 0.4% by weight of the syrup.

As with the other two syrups, other additives which are described hereinbelow may be present in the coloring syrup. It is preferred that the total solids in the coloring syrup ranges from about 67% to about 80% by weight, and more preferably from about 70% to about 75% by weight of the syrup.

The rest of the coloring syrup is water. Water is preferably present in amounts ranging from about 20% to about 33% by weight of the syrup and more preferably from about 27% to about 31% by weight of the syrup.

Preferably, the amount of coloring syrup added onto the confection in the third phase ranges from about 5.2% to about 6.8% and more preferably from about 5.7% to about 6.2% of the weight of the uncoated confection.

As discussed hereinabove, the various syrups may contain additives besides the sugars and the agents described hereinabove. These include sweetening agents, such as corn syrup, high fructose corn syrup, deionized corn syrup, honey, maple syrup, high maltose malt syrup, rice syrup, molasses, sorghum syrup, syrups made from sucrose, glucose, fructose, and invert sugar and the like as well as high intense sweeteners, e.g., such as aspartame, acesulfame K, saccharin, sucrolose, alitame, neotame, neohesperidin, thaumatin, sodium cyclamate or calcium cyclamate, and the like, flavoring agents, binders, e.g., plant gums, carboxymethylcellulose, gelatin or fatty substances, such as monoglycerides, diglycerides, and the like, anti-tack agents and antimicrobial agents, and the like.

These additives are present in total in small amounts, usually less than about 5% of the syrup by weight and more preferably, if present, from about 1% to about 3% by weight. Although each of the additives can be present in any of the syrups, it is preferred that if additional sweetening agents are present, it is present in the smoothing syrup. Thus, in an embodiment of the present invention, neither the gumming syrup nor the coloring syrup contain a sweetening agent (other than sugar), while the smoothing agent may be comprised of a sweetening agent (in addition to sugar). The other additives may be present in any of the syrups.

In a preferred embodiment, the gumming syrup is comprised of sugar (sucrose) and gumming agent and water. For example, a preferred gumming syrup is comprised of sucrose in an amount ranging from about 67% to about 78% by weight and more preferably from about 70% to about 74% by weight and a binding agent, e.g., gum arabic, in an amount from about 3% to about 5% and more preferably from about 2% to about 4%. Further, it is preferred that the water is present in amounts ranging from about 31% to about 20% by weight and more preferably from about 23% to about 26% by weight of the syrup.

A preferred smoothing agent is comprised of sugar (sucrose), a sweetener, as defined herein and a whitening agent, e.g., titanium dioxide. The preferred sweetener is corn syrup. It is preferred that the sugar is present in amounts ranging from about 67% to about 76%, and the sweetener is present in amounts of about 0.5% to about 4% and more preferably about 1% to about 3%. The whitening agent, e.g., titanium dioxide is preferably present in an amount ranging from about 1% to about 5% and more preferably from about 1.3% to about 3.5%. The water is preferably present in amounts ranging from about 31% to about 20% and more preferably from about 27% to about 29%.

The preferred coloring syrup comprises sugar, e.g., sucrose, and a coloring agent. It is preferred that the sugar is present in amounts ranging from about 67% to about 75% by weight and more preferably ranging from about 69% to about 71% by weight of the syrup. The coloring agent is preferably present in an amount ranging from about 1% to about 6% by weight and more preferably from about 2% to about 5% by weight of the coloring syrup. The percent solids in the coloring syrup preferably ranges from about 67% to about 80% and more preferably from about 69% to about 73% by weight of the syrup. Thus, water is preferably present in the coloring syrup in amounts ranging from about 20% to about 33% and more preferably from about 27% to about 31% by weight of the syrup.

Once the plurality of chocolate confections are placed in a coating pan, they are subjected to the coating process as described herein. Each of the syrups are applied onto the confectionery center as described herein. The application of each syrup to the confection is known as phases. Thus, the first phase in which the gumming syrup is applied onto the surface of the confection and then dried, in accordance with the process in the present invention, is referred to as the gumming phase, while the application of the smoothing syrup to the surface of the confectionery center uniformly covered with the gumming syrup and the subsequent drying thereof is referred to as the smoothing phase. Finally, the coloring of the confectionery center, such as by application of a coloring layer, and more preferably applying a coloring syrup, and any subsequently drying thereon will be referred to as the coloring phase.

The net result of applying the phases is that the resultant sugar shell over the confectionery center is comprised of at least two components: 1) the gum component or layer, and 2) the smoothing component or layer. If a coloring layer is applied onto the surface of the smoothing component then there is a third layer and it is called the color component or layer.

In the first phase, the gumming syrup is applied to the uncoated chocolates and then dried. In the second phase, the smoothing syrup is applied onto the surface of the confectionery products covered with the dried gumming syrup and dried. This second phase smoothes out the surface appearance of the coated products and if a coloring syrup is later applied, it also whitens the coated product. The third phase, which is optional, applies the coloring syrup onto the chocolates.

The second phase of the process does not commence until the first phase of applying the gumming syrup is completed and the third phase, if present, does not commence until the second phase applying the smoothing syrup is completed. During each phase, the coating pan is rotated. It is preferred that the coating pan rotates throughout each phase although the speed of the rotation may increase or decrease as more and more coating is applied to the confections. Thus, the pan speeds are preferably the slowest when applying the gumming syrup, and preferably the fastest when applying the coloring agent and are intermediate when applying the smoothing syrup.

Once the plurality of confectionery pieces are positioned in the coating pan they are subjected to a series of steps. More specifically, the gumming phase and the smoothing phase can be separated, in its broadest sense, into at least two steps; first, the application of the syrup, through an atomizer, onto the surface of the confectionery center and/or onto the surface of the dried gum layer covering the confectionery center, respectively, while rotating the coating pan containing the confectionery centers and then drying the syrups on the surface. In its broadest sense, the application of the syrup is completed before the drying step commences. After the drying step is completed, the next phase commences, and the steps repeat using the appropriate syrup.

However, it is preferred that each of the phases consists of at least three steps, the first step in the phase is the application of the syrup onto the surface of the confectionery center and/or the surface of the dried gumming layer on the confectionery center, respectively, while rotating the coating pan; the second step is the cessation of the application of the syrup and permitting the uniform distribution of the sugar syrup on the surface of the plurality of confectionery center while rotating the pan; and the third step is the drying of the sugar syrup. In this embodiment, the second step does not commence until the first step is completed, and the third step does not start until the second step is completed. When the last step of the phase is completed, the next phase commences, and the process is repeated, utilizing the appropriate syrup.

It is even more preferred that each phase consists of a series of steps which are basically repeated in a cycle.

More specifically, each cycle within a phase is comprised of the following basic steps which may be repeated unchanged, or slightly modified: Step 1) the application of a specific amount of atomized sugar syrup, Step 2) the uniform distribution of said sugar syrup over the surface of the plurality of centers for a specific time, Step 3) the drying of the sugar syrup for a specific time to a crystallized state, and, to such a degree as to accept another application of sugar syrup at which point the process repeats at Step 1. The sequence from the beginning of Step 1, to the beginning of the subsequent Step 1, constitutes the completion of one cycle. Thus, each of the coating phases includes spraying the syrup onto the plurality of confections using atomized spray nozzles, stopping the spraying, while still rotating the coating pan, causing the plurality of confections to tumble, thereby spreading the coating applied more uniformly and then drying the confections. In the first step, the surfaces of the confectionery center are sprayed. In the second step, there is no spraying. Instead, there is a standing step that occurs between the end of the step of applying the syrup and the drying of the plurality of confections. During this time, the plurality of confections are tumbled by rotating the drum of the coating pan containing the plurality of confections so as to more evenly distribute or spread the syrup over the surface of the confections (during which time no syrup is applied to the surface of the chocolates and during which no drying air is blown, into the rotating pan coating apparatus.) The spreading time in each phase varies, with the spreading time increasing from the gumming phase to the smoothing phase to the coloring phase. As used herein the term “spread times” refers to the amount of time that the confections are rotated in the pan after the coating is sprayed on them and before the air is applied onto them for drying.

The spreading allows the friction between each of the confection pieces as they are tumbling to spread out the syrup evenly onto the surfaces and over the preceding coating. This provides a full and even coating of the syrup of the confection.

The third step is drying. Once a coating of syrup is applied to the confection, the present invention contemplates drying the wet syrup in an inert medium. A preferred drying medium comprises air. More preferably, the drying air is in the temperature range of about 65° F. to about 95° F. The inventors also contemplate that the relative humidity of the drying air is less than about 15%. Preferably, the relative humidity of the drying air is less than about 8%.

The drying air may be passed over and mixed with the syrup coated confections in a way commonly known in the art. Preferably, the drying air is blown over and around the syrup coated confection at a volume sufficient to dry the coating. Preferably, the drying step is augmented by the use of an exhaust system to remove air from the pan while additional air is being pumped in to it. It is preferred that the spraying, spreading and drying steps of each cycle are repeated several times during each of the phases.

To ensure a uniform and consistent coated product having desired thickness, it is preferred that the spraying, tumbling, drying process for each phase is repeated over and over until the coating of desired thickness is obtained. In order to make an acceptable coating, the process can be repeated in total up to about 30 times or more and more preferably from about 13 to about 20 times or more with small-thin layers, being added each time. By the end of the each phase, the surface of the confectionery center is covered with a syrup and the syrup is uniformly spread thereon.

It is preferred that the spreading time in the gumming phase lasts for about 30 seconds to about 90 seconds and more preferably from about 40 seconds to about 60 seconds. It is also preferred that the spreading time in the smoothing phase lasts for about 30 seconds to 120 seconds and more preferably from about 40 to about 75 seconds. Finally, it is preferred that the spread time in the coloring phase lasts for about 30 seconds to about 3 minutes and more preferably from about 40 seconds to about 90 seconds.

During the various phases, the air volume onto which the dry air is blown onto the confection covered with the wet syrup to dry the syrup thereon varies. In addition, the relative humidity of the drying air and the speed of the rotation of the pan also varies.

It is preferred that the air volume blown onto the confection during drying of the gumming phase ranges from about 2.5 to about 20 cfm/lb (cubic feet per minute per pound of confection) and more preferably from about 3 to about 5 cfm/lb. In a preferred embodiment, the air temperature during the gumming phase ranges from about 73 F to about 85 F and more preferably from about 74 F to about 80 F, and the air dew point ranges from about 10 F to about 45 F and more preferably from about 10 F to 20 F. Further, during the gumming phase the peripheral pan speed is preferably rotated at a speed of about 18 to about 93 feet per minute and more preferably from about 18 to about 36 fpm.

During the smoothing phase, it is preferred that the air volume blown on the chocolate confection for drying the syrup therein ranges from about 2.5 to about 20 cfm/lb and more preferably from about 3 to about 5 cfm/lb. Preferably the air temperature ranges from about 75 F to about 95 F and more preferably from about 80 F to about 88 F, while the preferred dew point ranges from about 10 F to about 45 F and more preferably from about 10 F to about 20 F. The pan preferably rotates at a peripheral speed ranging from about 18 to about 93 feet per minute, and more preferably from about 36 to about 74 feet per minute. After the smoothing phase, a product is formed which can be eaten. At this juncture, the product is smooth but is uncolored. If the product is to be colored, the smoothing syrup must additionally contain a whitening agent, as described hereinabove, so that a third layer, a coloring layer, is applied after the smoothing phase onto the smoothing layer of the confectionery center. The coloring layer can be applied utilizing any techniques known in the art. However, it is preferred that the coloring layer is applied in similar fashion through an atomizer as described for the application of the other phases.

In the coloring phase, it is preferred that during the drying step, the air volume blowing onto the confection covered with the wet syrup ranges from about 2.5 to about 20 cfm/lb and more preferably from about 3 to about 5 cfm/lb of chocolate confection. The air temperature preferably ranges from about 75 F to about 85 F, and the air dew point preferably ranges from about 10 F to about 45 F and more preferably from about 10 F to about 20 F. The pan preferably rotates at a speed ranging from about 18 to about 93 feet per minute and more preferably from about 56 to about 93 fpm.

The present process is applicable to an irregularly shaped confection, e.g., chocolate, of any size normally utilized in the confectionery arts. However, it is preferred that the confection utilized in the present process is bited sized. In an embodiment, the confection is less than about 30 mm in height and more preferably less than about 18 mm in height. Preferably, it is greater than about 0.3 mm in height and more preferably greater than about 0.5 mm in height. Preferably, the length ranges from about 9 mm to about 17 mm and even more preferably from about 12 mm to about 14 mm. Moreover, it is preferred that the radius of the base of the chocolates ranges from about 1 mm to about 15 mm and more preferably from about 4 mm to about 8 mm and more preferably from about 5 mm to about 7 mm. In addition, it is preferred that the arc radius of the base of the confections ranges from about 5 mm to about 20 mm and more preferably from about 11 mm to about 15 mm and most preferably from about 13 mm to about 14 mm. Further, it is preferred that the weight of the confection, without the coating, preferably ranges from about 0.1 gm to about 5 gm and more preferably from about 0.6 gm to about 1.0 gm and most preferably from about 0.7 gm to about 0.9 gm.

By following the procedure of the present application, the coating on the confections achieves the desired thickness. It is preferred that the thickness of the sugar shell is that which is conventional in the confectionery arts. It is more preferred that the amounts of sugar shell added in total ranges from about 25% to about 40% by weight to the confectionery product and more preferably from about 25% to about 28%.

The above process enables the irregularly shaped product to be prepared by maintaining the contours of the irregular shape without substantial erosion and by maintaining the projecting tip(s) thereon. Under conventional coating systems, the contours of the irregular shape and more importantly the tips of the irregular shaped confection would be broken off and substantially eroded.

Although the various parameters described hereinabove are interrelated, it has been found that the maintenance of the tip of the irregularly shaped confection is primarily due to controlling the relationship of the pan speed, air dew point, air volume, and sugar syrup solids and air atomization for mixing the mist or droplets of the syrup that is applied onto the surface of the confectionery center.

Further, with respect to the parameters listed above, it was found by the inventors that each must be implemented and stringently controlled in order to realize successful hard panned sugar coating of the irregularly shaped confectionery centers.

As would be expected, the more coating added onto the confection, the greater is its tendency to be protected from external forces, such as erosion of the contour or tip resulting from the friction between each of the confectionery pieces and the coating pan and between other confectionery pieces or from the melting of the tip from the heat either in the air used in the drying or the spray or from the force that the spray or air contacts the confection. However, the confection is most vulnerable to erosion and breaking of the tip at the beginning of the process before the coating is added thereon. Moreover, in the coating process of the present invention, the temperature of the sugar solution being applied (in all three phases) is higher than the melting temperature of the confection, e.g., chocolate, which is about 85 F to about 92 F due to the high level of sugar solids required to quickly coat the plurality of centers. As indicated above, all three coating syrups contain a supersaturated solution of the sugar. The temperatures of the coating syrups must be sufficiently high so that the sugar does not crystallize before the syrups are dried after application thereof to the confection e.g., chocolate. Thus, the sugar cannot crystallize in the atomizer or in the syrup. However, too high temperature can result in the development of too much browning of the sugars which are present, resulting in burnt or bitter flavor ingredients and inversion which will inhibit the crystallization of the coating. It is preferred that the temperature of each of the syrups used in the process ranges from 140 F to about 180 F and more preferably from about 160 F to about 170 F.

Without air atomization, the syrup temperature required to prevent sugar crystallization of the syrup will melt the tips of the irregularly shaped, confectionery, e.g., chocolate, centers, which have a melting point of about 85 F to about 92 F; therefore, the air atomization must be great enough so as to evenly apply the coating to the centers as quickly as possible to prevent worn tips. The air atomization pressure is set to effectively form a fog to gently coat the plurality of irregularly shaped centers. The range of air atomization pressure ranges from about 14 to about 43 psi. After the gumming phase and partially through the smoothing phase the coating becomes thicker; thereby protecting the heat sensitive center. The air atomization becomes less critical and potentially can be reduced during the later phases of the process.

Furthermore, the pan speed of the coating pan must be high enough to ensure an even distribution of the coating syrup on the confection but low enough to reduce friction between it and the individual pieces of confection and between the confection pieces as they tumble during the rotation. As the pan speed increases, the likelihood of wearing off the coating increases due to the increased friction between the pieces; therefore during the gumming phase the pan speed is lower. After the gumming phase and partially through the smoothing phase the coating becomes thicker; therefore protecting the tips of the irregularly shaped center and the pan speed can be increased to more effectively smooth the piece surface without damaging the tips.

Finally, during drying the air volume must be high enough and the air dew point must be low enough to maximize drying to prevent wearing of the piece tips. Yet the air volume must be sufficiently low to allow sufficient spreading of the syrup onto the confection.

The present inventors have found that when the gumming syrup is applied at effective atomization pressures, the coating pan is rotated at an effective speed and the syrup is dried at an effective air volume, air relative humidity, and the syrup is comprised of the components described herein, the damage to the irregularly shaped chocolate, e.g., conical shaped, especially the protruding tip, is minimized.

After the gumming phase is complete, the air temperature, pan speed, and syrup solids can be changed while continuing to utilize air atomization as required to effectively coat the plurality of irregularly shaped centers. After all of the gumming syrup has been applied as a coating onto the confection, the resulting coating provides some protection from the heated forces described above in the smoothing step, and thus the air temperature can be increased when applying the smoothing syrup. Further, after the smoothing syrup has been applied as a second layer of coating, the two layers of coating provides protection from the forces described above, and thus the air temperature can be increased when the confections are being colored, for example, when the coloring syrup is applied thereto. In addition, the relatively humidity can be increased in the third phase.

As a result of the above process, the confection is subjected to the application of at least two coatings and more preferably three coatings and the resulting product has a hard sugar coating thereon. The confection thus prepared has a first sugar coating layer thereon comprised of the dried gumming syrup, and completely covering the first layer is the second layer comprised of the dried smoothing syrup. If the confection is to be white or colored, the smoothing agent contains the whitening agent, as described herein, and a third layer coating the smoothing layer is placed thereon which contains the coloring agent and which completely covers the confection. In a preferred embodiment, the layer coating the dried smoothing layer on the confection is comprised of a dried coloring syrup. As a result of the process, the confection is completely covered with a sugar coating with no bare spots. In addition, the contour of the irregular shaped confection is maintained and the tip is maintained.

The coated confectionery product may then optionally be polished using conventional techniques. In polishing, fatty substances or waxes known in the polishing are generally in crystallized form as flakes or in the form of alcoholic solutions, coats the confectionery products formed hereinabove with a very thin polishing film so as to reduce water transfers from or to the coated products and also make the surface thereof smooth. It is preferred that the coated confection is polished. In the polishing step a wax that is conventionally utilized in the art is evenly applied to impart a shiny surface on the coated confection. In addition, the polishing step also includes application of a sealer relatively evenly applied onto the wax coat to provide a water barrier thereon. Examples of polishers and sealers that can be utilized include carnuba wax and confectioner's glaze, respectively, and the like. The amount of polishing coat, if present, is typically ranging from 0.0% to about 0.5% by weight of the total coating.

As used herein, the weight percentage of the syrups is by weight of the syrup, which includes water. Moreover, as used herein, the weight of the confection refers to the weight of the confection prior to the addition of the sugar shell thereon.

As used herein, the air volume used to dry the confection is in units of cubic feet per minute per pound of chocolate without (in the absence of) coating thereon.

In the present application the singular refers to the plural and vice versa.

The following examples further illustrate the invention.

Reference to the “confection centers” or “confectionery centers” or synonyms used herein refer to the confections that are in the pan of the coating pan apparatus. In this context, the term “confections” and “confection centers” or “confectionery centers” or synonyms thereto are being used interchangeably. In the following examples and herein the term “centers” when used alone or in combination with other terms, such as “confection” or “confectionery” and/or synontms thereto, refers to that portion of the irregularly shaped bite-size “confection”, such as chocolate, without the sugar coating thereon. In the following examples, the center used was a bite-sized Hershey's Kisses® chocolate.

### EXAMPLE 1

Twenty two pounds of bite-sized heat sensitive Hershey's Kisses® chocolate centers with rounded bottoms were loaded into a 2 foot diameter perforated pan. The centers were cooled to 64 F. Centers were tumbled in the perforated pans at five revolutions per minute or 31.4 feet per minute peripheral speed. A solution of gum arabic syrup, 72% solids solution of sugar, gum arabic and water, were sprayed at a rate of 0.44 pounds per minute on the centers using air atomized spray nozzles. The gum syrup provides protection for the tip, acts as a binding agent and prepares the surface for sugar coating. Dose sizes ranged from 0.48 to 0.57 pounds of syrup. Air atomization was set at 29 psi and remained constant during the entire process. After each application of gum syrup, the product was allowed to spread without air for 40 to 60 seconds. Air was then applied and the product was dried with 80.6-82.4 F air at a dew point of 36 F for about six to seven minutes. The air volume was directly applied to the product at a volume of 90 cubic feet per minute. There were eight to ten repetitions of gum syrup applied to the product during the gumming phase.

As the product surface became harder and less heat sensitive, the next phase of sugar coating was started. Smoothing syrup, made of sugar, water, dextrose syrup and titanium dioxide at 70% solids, was applied to the centers in a similar manner as the gum syrup. The syrup application rate remained at 0.44 to 0.51 pounds per minute. Dose sizes during this phase ranged from 0.40 to 0.44 pounds. After each application of smoothing syrup, the product was allowed to spread for about 40 to 75 seconds. Air was applied to the product. Since the product was becoming more heat stable, the air temperature was raised to 84.2-87.8 F with a dew point of 36 F. The air volume remained constant at 90 cubic feet per minute. The drying times during the smoothing phase ranged from five to six minutes. The pan speed remained at five revolutions per minute for five doses. After five doses of smoothing syrup were applied, the pan speed was increased to seven revolutions per minute. There were eight to ten repetitions of smoothing syrup applied to the product during the smoothing phase.

The final coating phase of the centers was the coloring phase. During the coloring phase, a 69% solids sugar, water and lake color syrup was applied in a similar manner as the other syrups. The syrup application rate was increased to 0.88 pounds per minute. Dose sizes during the coloring phase were reduced to 0.33 to 0.37 pounds as the product became smoother. The pan speed was increased to eight to ten revolutions per minute or 50.2 to 62.6 feet per minute peripheral speed. The air volume remained at 90 cubic feet per minute. Air temperature was reduced from 77.0 to 82.4 F at a dew point of 36 F. (Air atomization can optionally be reduced during this phase to 23 psi.) There were seven to nine repetitions of coloring syrup applied to the product during the coloring phase.

During final three doses of color syrup the dose sizes were reduced to 0.13 to 0.18 pounds. The spread time was increased to about four minutes. The air was only applied for about 20 to 30 seconds for each application. The air volume was reduced to 70 cubic feet per minute to prevent over drying the product. The final sugar shell percentage of the product was between 26-30%. After the product was coated, it can be polished using conventional methods.

### COMPARATIVE EXAMPLE 1

The process of Example 1 is repeated except that the confections used has flat bottoms. The results of this process is that the pieces are stuck together at the bases.

### COMPARATIVE EXAMPLE 2

Twenty four hundred pounds of bite sized heat sensitive Hershey's Kisses® chocolate centers, which were previously precoated with a gum arabic and sucrose syrup mixture were loaded into a 6.6 foot diameter perforated pan. The centers were cooled to 64 F. Centers were tumbled in the perforated pan at two revolutions or 41.4 feet per minute peripheral speed per minute. A solution of sucrose syrup, 76% solids of sugar and water, was pumped at a rate of 25 pounds per minute on the centers using syrup nozzles, without air atomization. The function of the sugar syrup is to prepare the surface for the smoothing coats. However, in this example, no binding agent was present in the first syrup. Dose sizes ranged from 42 to 75 pounds of syrup. After each application of sucrose syrup, the product was allowed to spread without air for 60 to 80 seconds. Air was then applied, and the product was dried with 75 F air at a dew point between 42-52 F for about nine to ten minutes. The air volume was directly applied to the product at a volume of 5300 cubic feet per minute. There were about four repetitions of sucrose syrup applied to the product during the sucrose syrup phase.

As the product surface becomes harder and less heat sensitive, the next phase of sugar coating was started. Smoothing syrup, made of sugar, water, glucose syrup and titanium dioxide at 70% total solids, was applied to the centers in a similar manner as the syrup above was applied. The syrup application rate remained at 25 pounds per minute. Dose sizes during this phase ranged from 33-44 pounds. After each application of smoothing syrup, the product was allowed to spread for 60-80 seconds. Air was applied to the product. Since the product was becoming more heat stable, the air temperature was raised to 80-85 F with a dew point of 42-52 F. The air volume remained constant at 5300 cubic feet per minute. The drying times during the smoothing phase ranged from five to nine minutes. The pan speed increased from two revolutions to 2.5 revolutions per minute or 41.4 to 51.8 feet per minute peripheral speed from five doses. After five doses of smoothing syrup were applied, the pan speed was increased to three revolutions per minute or 62.2 feet per minute peripheral speed. There were eight to ten repetitions of smoothing syrup applied to the product during the smoothing phase.

The final coating phase of the centers was the coloring phase. During the coloring phase, a 69 to 72% solids sugar, water and lake color syrup were applied in a similar manner as the other syrups. The syrup application rate remained at 25 pounds per minute. Dose sizes during the coloring phase were reduced to 22 to 29 pounds as the product became smoother. The pan speed was maintained at three revolutions per minute or 62.2 feet per minute peripheral speed. The air volume remained at 5300 cubic feet per minute. Air temperature was raised to 85-87 F at a dew point of 42 to 52 F. There were seven to thirteen repetitions of coloring syrup applied to the product during the coloring phase.

During the final two doses of color syrup, the dose sizes were reduced to 14 to 20 pounds. The spread time was increased to about eight to ten minutes. Air was only applied for about 15 to 30 seconds for each application. The air volume was reduced to 4300 cubic feet per minute, and the air temperature reduced to 70-82 F to prevent over drying the product. The pan speed was increased to 4 revolutions per minute. The final sugar shell percentage of the product was between 26-30%. After the product was coated it can be polished using conventional methods.

In this example, the centers were coated without using air atomization, but rather coating was applied using a pump. No binding agent was present in the first syrup that was applied to the center. The product that was produced was unsatisfactory. A large percentage of the product had bare tips. Moreover, there was a significant amount of tip wearing which was significantly much greater than when the product is prepared under the conditions of the present invention, described hereinabove. Moreover, unlike the products produced in accordance with the present process in which the product produced has a smooth surface, the product produced by Comparative Example 2 had a rough surface.

The above preferred embodiments and examples are given to illustrate the scope of and spirit of the present invention. The embodiments and examples described herein will make apparent to those skilled in the art other embodiments and examples. These other embodiments and examples are within the contemplation of the present invention. Therefore, the present invention should be limited only by the appended claims.

What is claimed is:

1. A sugar coated irregularly shaped bite sized confection.

2. The sugar coated irregularly shaped bite sized confection according to claim 1 wherein the confection is chocolate.

3. The sugar coated irregularly shaped bite sized confection according to claim 1 in which the confection is uniformly coated with at least two syrups dried thereon, the bottom layer of syrup is comprised of a dried gumming syrup comprised of a supersaturated solution of crystallizable sugar and a binding agent and the second layer of dried syrup is comprised of a dried smoothing syrup comprised of a supersaturated solution of crystallizable sugar and non-crystallizable sugar, said binding agent being present in sufficient quantities to cover the surface of the confection and bind said smoothing syrup onto the gumming syrup coating the surface of the confection, and said smoothing agent being present in sufficient quantities to smooth out the coated surface of the confection and the non-crystallizable sugar being present in amounts sufficient to prevent crystallization of the sugar in the smoothing layer.

4. The sugar coated irregularly shaped bite sized confection, according to claim 3, wherein the total amount of crystallizable sugar present in the gumming syrup ranges from about 67% to about 78% (w/w) and total solids therein ranges from about 69% to about 80% (w/w).

5. The sugar coated irregularly shaped bite sized confection according to claim 4 wherein the amount of crystallizable sugar present in the gumming syrup ranges from about 70 to about 74% by weight and the total solids ranges from about 74 to about 77% by weight.

6. The sugar coated irregularly shaped bite sized confection according to claim 3 wherein the binding agent comprises from about 3% to about 5% by weight of the gumming syrup.

7. The sugar coated irregularly shaped bite sized confection according to claim 3 wherein the smoothing syrup is comprised of crystallizable sugar ranging from about 67% to about 76% sugar and the total solids ranging from about 69% to about 80% solids.

8. The sugar coated irregularly shaped bite sized confection according to claim 3 wherein the crystallizable sugar present in the smoothing syrup range from about 70% to about 74% by weight and the total solids ranges from about 71% to about 75% by weight of syrup.

9. The sugar coated irregularly shaped bite sized confection according to claim 3 wherein the binding agent is glucose syrup, gum arabic, xanthan gum, gelatin, gum tragacanth, or maltodextrin.

10. The sugar coated irregularly shaped bite sized confection according to claim 9 wherein the binding agent is gum arabic.

11. The sugar coated irregularly shaped bite sized confection according to claim 1 in the shape of a cone.

12. The sugar coated irregularly shaped bite sized confection according to claim 3 where the amount of non-crystallizable sugar present in the smoothing syrup ranges from about 1% to about 3% by weight of the smoothing syrup.

13. The sugar coated irregularly shaped bite sized confection according to claim 3 wherein the non-crystallizable sugar is glucose syrup, corn syrup or sorbitol.

14. The sugar coated irregularly shaped bite sized confection according to claim 3 wherein a dried coloring syrup is additionally present and is the top most syrup completely covering said confection and wherein the smoothing syrup additionally comprises a whitening agent.

15. The sugar coated irregularly shaped bite sized confection according to claim 14 wherein the coloring syrup comprises a supersaturated solution of sugar ranging from about 67% to about 75% by weight of the syrup and a coloring agent, wherein the total solid therein ranges from about 67% to about 80% by weight.

16. The sugar coated irregularly shaped bite sized confection according to claim 17 wherein the whitening agent in the smoothing syrup is titanium dioxide or calcium carbonate.

17. The sugar coated irregularly shaped bite sized confection according to claim 16 wherein the whitening agent is titanium dioxide.

18. The sugar coated irregularly shaped bite sized confection according to claim 14 wherein the crystallizable sugar in the gumming, smoothing and coloring syrups is sucrose, the binding agent is gum arabic, the non-crystallizable sugar in the smoothing syrup is corn syrup, and the whitening agent is titanium dioxide.

19. The sugar coated irregularly shaped bite sized confection according to claim 3 wherein said confection is polished.

20. The sugar coated irregularly shaped bite sized confection according to claim 14 wherein said confection is polished.

21. The bite sized irregularly shaped confection according to claim 18 wherein said confection is polished.

22. A process for sugar coating with at least two syrups a plurality of bite sized irregularly shaped confections having a non-flat base which comprises
(a) placing said plurality of irregularly shaped confections into a coating pan apparatus equipped with (1) a coating pan comprised of a rotable drum into which irregularly shaped plurality of confections are placed, said drum being controlled by a variable speed drive which controls the speed of the rotation of the drum, (2) an air atomizer that sprays a fine mist of each of the syrups onto the plurality of irregularly shaped confections; (3) an air inlet line and air outlet line each extending from outside of the coating pan apparatus into the interior thereof juxtaposed above and below respectively, the coating pan, said lines juxtaposed in a position to blow air onto or draw air away, respectively, from the plurality of irregularly shaped confections said air blowing into the drum having a designated range of dew points; and (4) tanks and lines leading from said tanks which supply syrups to said atomizer;
(b) spraying a gumming syrup comprised of a supersaturated solution of crystallizable sugar and a binding agent onto the surface of the plurality of confections through an atomizer while rotating said drum of the coating pan containing said plurality of confections under conditions effective to uniformly coat the confections with said gumming syrup and in an amount effective to bind a smoothing syrup thereon, and subsequently drying said gumming syrup coating said confection, said gumming syrup comprised of a crystallizable sugar ranging from about 67% to about 78% (w/w) and total solids therein ranging from about 69% to about 80% (w/w) of said gumming syrup, said gumming syrup being dried at a dew point ranging from about 10 to about 45 F, said drum being rotated at a peripheral speed ranging from about 18 to about 93 feet per minute and the air volume blown onto the plurality of confections ranging from about 2.5 to about 20 cubic feet/per minute per pound of confection;
(c) spraying said smoothing syrup comprised of a supersaturated solution of crystallizable sugar and non-crystallizable sugar onto the surface of the product of (b) through an atomizer while rotating said drum of the coating pan containing the product of (b) under conditions effectively to uniformly coat the dried gumming syrup coating the confections in an amount effective to smooth the coated surface of the product of (b), said non-crystallizable sugar being present in an amount sufficient to prevent the crystallization of the sugar in the smoothing syrup on the confections, and then subsequently drying the smoothing syrup thereon, whereby the total amount of crystallizable sugar present in the smoothing syrup ranges from about 67% to about 76% (w/w) sugar and the total solids present in the syrup ranging from about 69% to about 80% (w/w), said smoothing syrup being dried on the surface of the resulting product at a dew point ranging from about 10 to about 45 F, and the air volume blowing onto the plurality of confections ranging from about 2.5 to about 20 cubic feet/per minute per pound of confections, said drum being rotated at a peripheral speed ranging from about 18 to about 93 fpm.

23. The process according to claim 22 wherein the base of the confection is rounded.

24. The process according to claim 22 wherein the confection is chocolate.

25. The process according to claim 22 wherein the drum of the coating pan is perforated.

26. The process according to claim 22 wherein the coating pan comprises a plurality of baffles.

27. The process according to claim 24 wherein each of the syrups that passes through the atomizer is heated at a temperature above the melting point of the confection.

28. The process according to claim 27 wherein the temperature of each of the syrups passing through said atomizer ranges from about 140 F to about 180 F.

29. The process according to claim 22 wherein each of (b) and (c) comprises three steps; a first step wherein a specified amount of atomized sugar is applied onto the surface of the confection; a second step wherein the spraying through an atomizer is halted while still rotating the drum, for sufficient amount of time for the sugar syrup to uniformly distribute over the surface of each of the confections; and a third step where the syrup applied onto the surface of the confection is dried and where the second step commences at the conclusion of the first step and the third step commences at the conclusion of the second step.

30. The process according to claim 29 wherein the first step, second step and third step in (b) and (c) is repeated for a total of about 13 to about 20 or more times.

31. The process according to claim 29 where, the air volume blown onto the plurality of confections in (b) ranges from about 3 to about 5 cfm/lb of uncoated confection, the air dew point of (b) ranges from about 10 F to about 20 F, the pan is rotating at a peripheral speed in (b) from about 18 to about 36 ft/min, and the amount of sugar present in the gumming syrup ranges from about 70 to about 74% by weight thereof and the total amount of solids in the gumming syrup ranges from about 74 to about 77% by weight.

32. The process according to claim 29 wherein the radius of the nozzle of the atomizer through which the syrup passes in order to spray the confections ranges from about 1.1 to about 1.9 mm.

33. The process according to claim 29 wherein the mean volume of the syrup droplets sprayed onto the confection from the atomizer ranges from about 15 to about 400 microns.

34. The process according to claim 29 where in (c) the amount of sugar solids present in the smoothing syrup ranges from about 70% to about 74% by weight and the total amount of solids in (c) ranges from about 71 to about 75%, by weight the air volume blown onto the plurality of confections ranges from about 3 to about 5 cfm/lb, the dew point in (c) ranges from about 10 to about 20 F, and the pan is rotating in (c) at a peripheral speed ranging from about 36 to about 74 feet per minute.

35. The process according to claim 29 where in step (b) the air atomization pressure ranges from about 14 to about 43 psi and the gumming syrup is dried at a temperature ranging from about 73 F to about 85 F.

36. The process according to claim 35 where in (c), the air atomization pressure ranges from about 14 to about 43 psi and the temperature of the air ranges from about 65 to about 95 F.

37. The process according to claim 22 wherein the smoothing syrup additionally comprises a whitening agent and the process additionally comprises (d) coloring the confection produced in (c).

38. The process according to claim 37 wherein coloring comprises applying a coloring syrup onto the surface of the product of (c) to uniformly cover and coat the product of (c) and drying the coloring syrup thereon.

39. The process according to claim 37 wherein the product of step (d) is polished.

40. The process according to claim 38 wherein the coloring syrup is comprised of a supersaturated solution of sugar and a coloring agent.

41. The process according to claim 40 wherein the coloring syrup is comprised of a crystallizable sugar ranging from about 67% to about 75% (w/w) and the total solids ranging therein from about 67% to about 80%, by weight.

42. The process according to claim 41 wherein the coloring syrup is applied onto the product of (c) by spraying through an atomizer while rotating the drum of the coating pan containing the product of (c), the coloring syrup being applied onto the surface of the product of step (c) to color uniformly said product of step (c), and subsequently drying the coloring syrup thereon, said process being effected while rotating the drum of the coating pan at a peripheral pan speed ranging from about 18 to about 93 fpm and said syrup being dried at an air dew point of about 10 to about 45 F and an air volume blowing onto the plurality of the confections ranging from about 2.5 to about 20 cfm/lb.

43. The process according to claim 23 wherein the rounded base is formed from confections having flat bases by rounding the contour of said flat base of each of said confections.

44. In an improved process for sugar coating an irregularly shaped bite sized confection having a rounded bottom wherein the sugar coating process comprises coating the confection in at least two phases consisting of a gumming and smoothing phases, utilizing a gumming syrup and a smoothing syrup, respectively, and optionally a coloring phase utilizing a coloring syrup, the coating is effected in a coating pan comprised of a rotatable drum into which the irregularly shaped confections are placed, said drum being controlled by a variable speed drive which controls the speed of the rotation of the drum, an air atomizer spraying a fine mist of each of the syrups onto the plurality of irregularly shaped confections, an air inlet line and air outlet line each extruding from outside of the coating pan, said air lines juxtaposed above and below respectively, the coating pan and drawing air onto or away, respectively, from the plurality of confections and said tanks and lines leading from tanks to the atomizer, the improvement comprising spraying a gumming syrup comprised of a supersaturated solution of crystallizable sugar and a binding agent onto the surface of the plurality of confections through an atomizer while rotating said drum of the coating pan containing said plurality of confections under conditions effective to uniformly coat the confections with said gumming syrup, and subsequently drying said gumming syrup thereon, said gumming syrup comprised of a crystallizable sugar ranging from about 67% to about 78% (w/w) and total solids therein ranging from about 69% to about 80% (w/w) of said gumming syrup, said gumming syrup being dried at a dew point ranging from about 10 F to about 45 F, said drum being rotated at a peripheral speed ranging from about 18 to about 93 feet per minute and the air volume blown onto the plurality of confections ranging from about 2.5 to about 20 cubic feet/per minute per pound of confection.

45. The improved process according to claim 44 wherein the confection is chocolate.

46. The improved process according to claim 45 wherein the improved process is comprised of three steps; a first step wherein a specified amount of atomized sugar is applied onto the surface of the confection; a second step wherein the spraying through an atomizer is halted while still rotating the drum, for sufficient amount of time for the sugar syrup to uniformly distribute over the surface of each of the confections; and a third step where the syrup applied onto the surface of the confection is dried and where the second step commences at the conclusion of the first step and the third step commences at the conclusion of the second step.

47. The improved process according to claim 46 where the first step, second step, and third step in each is repeated 13 to about 20 or more times.

48. The improved process according to claim 46 wherein the air volume blown onto the plurality of confections ranges from about 3 to about 5 cfm/lb.

49. The improved process according to claim 46 wherein the air dew point ranges from about 10 to about 20 F.

50. The improved process according to claim 46 wherein the pan is rotated at a peripheral speed of about 18 to 30 fpm.

51. In an improved process for sugar coating an irregularly shaped bite sized confection having a rounded bottom wherein the sugar coating process comprises coating the confection in at least two phases consisting of a gumming and smoothing phases, utilizing a gumming syrup and a smoothing syrup, respectively, and optionally a coloring phase utilizing a coloring syrup, and the coating is effected in a coating pan comprised of a rotatable drum into which the irregularly shaped confections are placed, said drum being controlled by a variable speed drive which controls the speed of the rotation of the drum, an air atomizer spraying a fine mist of each of the syrups onto the plurality of irregularly shaped confections, an air inlet line and air outlet line each extruding from outside of the coating pan, said air lines juxtaposed above and below respectively the coating pan and drawing air into or away respectively from the plurality of confections and tanks and lines leading from tanks to the atomizer, wherein the dried gumming syrup coats the surface of the plurality of confections, the improvement comprising spraying a smoothing syrup comprised of a supersaturated solution of crystallizable sugar and non-crystallizable sugar onto the dried gumming syrup on the surface of the confections through an atomizer while rotating said drum of the coating pan containing said confection under conditions effectively to uniformly coat the dried gumming syrup on the surface of the confections in an amount effective to smooth the coating of the surface of the confections, and subsequently drying the smoothing syrup thereon, said non-crystallizable sugar being present in an amount sufficient to prevent the crystallization of the sugar in the smoothing syrup onto the surface of the product of the confection, whereby the total amount of crystallizable sugar present in the smoothing syrup ranges from about 67% to about 76% (w/w) sugar and the total solids present in the syrup ranging from about 69% to about 80% (w/w), said smoothing syrup being dried on the surface of the resulting product at a dew point ranging from about 10 to about 45 F, and the air volume blowing onto the plurality of confections ranging from about 2.5 to about 20 cfm/lb per pound of confections, said drum being rotated at a peripheral speed ranging from about 18 to about 93 fpm.

52. The improved process according to claim 51 wherein the confection is chocolate.

53. The improved process according to claim 51 wherein the improved process is comprised of three steps; a first step wherein a specified amount of atomized sugar is applied onto the surface of the confection; a second step wherein the spraying through an atomizer is halted while still rotating the drum, for sufficient amount of time for the sugar syrup to uniformly distribute over the surface of each of the confections; and a third step where the syrup applied onto the surface of the confection is dried and where the second step commences at the conclusion of the first step and the third step commences at the conclusion of the second step.

54. The improved process according to claim 53 wherein the air dew point range from about 10 F to about 20 F.

55. The improved process according to claim 53 wherein the amount of sugar solids present in the smoothing syrup ranges from about 70% to about 74% by weight and the total amount of solids ranges from about 71 to about 75% by weight.

56. The improved press according to claim 53 wherein the air volume blown onto the plurality of confection ranges from about 3 to about 5 cfm/lb.

57. The improved process according to claim 53 wherein the pan is rotating at a peripheral speed ranging from about 36 to about 74 ft/min.

58. The improved process according to claim 53 wherein the amount of sugar solids present in the smoothing syrup ranges from about 70% to about 74% by weight and the total amount of solids ranges from about 71 to about 75% by weight, the air volume blown onto the plurality of confection ranges from about 3 to about 5 cfm/lb and the dew point ranges from about 10 to about 20 F and the pan is rotated at the speed ranging from about 36 to about 74 ft/min.

59. The product produced by the process of claim 22.

60. The product produced by the process of claim 22 wherein the confection is chocolate.

61. The process according to claim 22 wherein in (b), the air atomization pressure ranges from 14 to about 43 psi.

62. The process according to claim 22 wherein in (c), the air atomization pressure ranges from about 14 to about 43 psi.

63. The process according to claim 22 wherein in (b), the volume mean diameter of the droplet in the spray ranges from about 15 to about 400 microns.

64. The process according to claim 22 wherein in (c), the volume mean diameter of the droplet in the spray ranges from about 15 to about 400 microns.
